(19) United States
(12) Patent Application Publication
(10) Pub. No.: US 2026/0006368 A1
(43) Pub. Date: Jan. 1, 2026

(54) EARPHONES AND WEARING COMPONENTS

(71) Applicant: SHENZHEN SHOKZ CO., LTD., Shenzhen (CN)

(72) Inventors: Yueqiang WANG, Shenzhen (CN); Song YOU, Shenzhen (CN); Yingying ZHANG, Shenzhen (CN)

(73) Assignee: SHENZHEN SHOKZ CO., LTD., Shenzhen (CN)

(21) Appl. No.: 19/319,698

(22) Filed: Sep. 4, 2025

Related U.S. Application Data
(63) Continuation of application No. PCT/CN2024/076068, filed on Feb. 5, 2024.

(51) Int. Cl. H04R 1/10

(52) U.S. Cl. CPC H04R 1/105; H04R 1/1008

(57) ABSTRACT

The present disclosure provides an earphone and a wearing component. The wearing component comprises a headband component including a clamping component, a wire, and a first elastic wrapping body. The clamping component has a length direction, a thickness direction, and a width direction, the clamping component has a curved shape along the length direction, so that the headband component is wound around a top of a head of a user and provides a clamping force when the wearing component is in a wearing state, a dimension of the clamping component along the width direction is greater than a dimension of the clamping component along the thickness direction, and the thickness direction faces or is away from the head of the user when the wearing component is in the wearing state.

### CROSS-REFERENCE TO RELATED APPLICATIONS

This application is a continuation of International Application No. PCT/CN2024/076068, filed on Feb. 5, 2024, the entire contents of which are incorporated herein by reference.

### TECHNICAL FIELD

The present disclosure relates to the technical field of electronic devices, and in particular, to an earphone and a wearing component.

### BACKGROUND

With the widespread adoption of electronic devices, electronic devices have become indispensable tools for social interaction and entertainment in daily lives, and users now have increasingly higher expectations for electronic devices. Electronic devices such as earphones and smart glasses are widely used in everyday scenarios and can be paired with terminals like smartphones and computers to provide users with an immersive auditory experience. However, wearing components of current earphones tend to exert pulling force on the wires during use, which adversely affects the structural stability of the wearing component.

### SUMMARY

In a first aspect, the present disclosure provides a wearing component, comprising a headband component. The headband component includes a clamping component, a wire, and a first elastic wrapping body, the clamping component has a length direction, a thickness direction, and a width direction, the clamping component has a curved shape along the length direction, so that the headband component is wound around a top of a head of a user and provides a clamping force when the wearing component is in a wearing state. A dimension of the clamping component along the width direction is greater than a dimension of the clamping component along the thickness direction, and the thickness direction faces or is away from the head of the user when the wearing component is in the wearing state. The first elastic wrapping body includes a wrapping main body, the wrapping main body is molded to enclose an outer periphery of the clamping component and the wire, and the clamping component and the wire located within the wrapping main body at least partially overlap along the thickness direction.

In some embodiments, a ratio of an overlapping dimension between the clamping component and the wire along the thickness direction to a smaller one of the dimension of the clamping component along the thickness direction and a dimension of the wire along the thickness direction is in a range from 0.6 to 1.

In some embodiments, a ratio of the dimension of the clamping component along the thickness direction to the dimension of the wire along the thickness direction is in a range from 0.5 to 2.

In some embodiments, the first elastic wrapping body further includes an elastic band integrally molded with the wrapping main body, two ends of the elastic band are spaced apart from each other along the length direction and are respectively connected to the wrapping main body, the elastic band and the wrapping main body are separated from each other between connection positions of the two ends of the elastic band and the wrapping main body, and the elastic band is configured to assist in positioning the clamping component onto the head of the user when the wearing component is in the wearing state.

In some embodiments, the wearing component is configured to, when the wearing component is in the wearing state, place a loudspeaker component at an ear of the user or a listening region near the ear, and along a sagittal axis of the user, the loudspeaker component is closer to a face of the user relative to the clamping component, and the wire is closer to a rear side of the head relative to the clamping component.

In some embodiments, the clamping component includes an elastic sheet, and the wire is arranged on a side of the elastic sheet along the width direction and at least partially overlaps with the elastic sheet along the thickness direction.

In some embodiments, the clamping component includes two elastic sheets disposed side by side along the width direction, and the wire is arranged between the two elastic sheets along the width direction or on a side of one elastic sheet that is away from the other elastic sheet, and the wire at least partially overlaps with the two elastic sheets along the thickness direction.

In some embodiments, the clamping component includes two elastic sheets stacked along the thickness direction, and the wire is sandwiched between the two elastic sheets.

In some embodiments, two ends of the clamping component are exposed from the first elastic wrapping body. The wearing component further comprises a telescopic component, and the telescopic component and the clamping component are assembled and fixed through an exposed end portion of the first elastic wrapping body.

In some embodiments, the telescopic component includes a fixing portion, a locking member, and a telescopic portion, the fixing portion is provided with a first plug-in hole and a first locking hole in communication with the first plug-in hole, an end portion of the clamping component is inserted into the first plug-in hole, and the locking member is inserted into the first locking hole and locks the end portion of the clamping component within the first plug-in hole.

In some embodiments, the telescopic component further includes a decorative portion, the fixing portion is provided with a sliding groove. The telescopic portion is slidably disposed in the sliding groove, the first locking hole and the sliding groove are provided on a side of the fixing portion facing the user when the wearing component is in the wearing state. The decorative portion is assembled and fixed with the fixing portion to cover the first locking hole, the sliding groove, and a portion of the telescopic portion located within the sliding groove.

In some embodiments, the end portion of the clamping component has a sheet-like shape and is provided with a second locking hole passing through main surfaces on two sides of the end portion of the clamping component. The first locking hole and the second locking hole are aligned when the end portion of the clamping component is inserted into the first plug-in hole, and the locking member is a pin inserted into the first locking hole and the second locking hole. The first elastic wrapping body further includes an embedding portion integrally molded with the wrapping main body, the embedding portion is attached to the main surface on one side of the end portion of the clamping component. The fixing portion is provided with a second plug-in hole in communication with the first plug-in hole, and the embedding portion is inserted into the second plug-in hole.

In some embodiments, the telescopic component includes the fixing portion and a telescopic portion that is telescopic relative to the fixing portion. The wearing component comprises a torsion component, the torsion component includes an elastic connecting member, one end of the elastic connecting member is connected to the telescopic portion, and the other end of the elastic connecting member is connected to the loudspeaker component. The elastic connecting member is configured to undergo torsion as the loudspeaker component contacts the head of the user when the wearing component is in the wearing state.

In some embodiments, the elastic connecting member is an elastic metal wire.

In some embodiments, the wire extends from an outside of the telescopic component to the torsion component and is fixed to the torsion component, and a length of the wire outside the telescopic component is greater than a maximum extension amount of the telescopic component.

In some embodiments, the torsion component includes a second elastic wrapping body, the second elastic wrapping body is molded to enclose an outer periphery of the elastic connecting member and is provided with a wiring channel, and the wire passes through the wiring channel.

In a second aspect, the present disclosure provides an earphone, comprising the wearing component and a loudspeaker component connected to the wearing component. The wearing component is configured to, in a wearing state, place the loudspeaker component in a facial region in front of a tragus of the user.

The beneficial effect of the present disclosure is as follows: through the above configuration, tension or compression on the wire during deformation of the clamping component can be reduced, thereby extending the service life of the wire. At the same time, the deformation consistency between the clamping component and the wire is improved, which enhances the structural stability of the wearing component.

### BRIEF DESCRIPTION OF THE DRAWINGS

To more clearly illustrate the technical solutions in the embodiments of the present disclosure, the following will briefly introduce the accompanying drawings that need to be used in the description of the embodiments, and it will be obvious that the accompanying drawings in the following description are only some of the embodiments of the present disclosure, and for a person of ordinary skill in the art, other drawings can be obtained according to these drawings without creative work.

FIG. a1 is a schematic diagram illustrating an exemplary three-dimensional structure of an earphone according to embodiments of the present disclosure;

FIG. a2 is a schematic diagram illustrating an exemplary disassembled structure of an earphone according to embodiments of the present disclosure;

FIG. a3 is a schematic diagram illustrating a wearing state of an earphone according to embodiments of the present disclosure;

FIG. 1 is a schematic diagram illustrating an exemplary three-dimensional structure of an earphone according to embodiments of the present disclosure;

FIG. 2 is a schematic diagram illustrating an exemplary disassembled structure of the earphone shown in FIG. 1 and an enlarged view of A20;

FIG. 3 is a schematic diagram illustrating an exemplary side structure of an earphone according to embodiments of the present disclosure;

FIG. 4 is a schematic diagram illustrating an exemplary cross-sectional structure of the earphone shown in FIG. 1 along a E21-E21 section line;

FIG. 5 is a schematic diagram illustrating an exemplary structure of A21 of the earphone shown in FIG. 4;

FIG. 6 is a schematic diagram illustrating another exemplary structure of A21 of the earphone shown in FIG. 4;

FIG. 7 is a schematic diagram illustrating another exemplary structure of A21 of the earphone shown in FIG. 4;

FIG. 8 is a schematic diagram illustrating another exemplary structure of A21 of the earphone shown in FIG. 4;

FIG. 9 is a schematic diagram illustrating an exemplary cross-sectional structure of a headband component and a telescopic component shown in FIG. 1;

FIG. 10 is a schematic diagram illustrating an exemplary structure of A22 shown in FIG. 9;

FIG. 11 is a schematic diagram illustrating an exemplary disassembled structure of an earphone with some parts hidden according to embodiments of the present disclosure;

FIG. 12 is a schematic diagram illustrating an exemplary disassembled structure of a portion of an earphone according to embodiments of the present disclosure;

FIG. 13 is a schematic diagram illustrating an exemplary connecting structure of a stick microphone component and a loudspeaker component;

FIG. 14 is a schematic diagram illustrating an exemplary disassembled structure of the structure shown in FIG. 13;

FIG. 15 is a schematic diagram illustrating an exemplary disassembled structure of the structure shown in FIG. 13 with some parts hidden;

FIG. 16 is a schematic diagram illustrating an exemplary structure including a limiting groove and a limiting protrusion;

FIG. 17 is a schematic diagram illustrating an exemplary cross-sectional structure of a stick microphone component;

FIG. 18 is a schematic diagram illustrating an exemplary structure of a stick microphone component with some parts hidden;

FIG. 19 is a schematic diagram illustrating an exemplary cross-sectional structure of a portion of a stick microphone component along a E91-E91 section line;

FIG. 20 is a schematic diagram illustrating another exemplary cross-sectional structure of a portion of a stick microphone component and a loudspeaker component along the E91-E91 section line;

FIG. 21 is a schematic diagram illustrating an exemplary disassembled structure of a rotating shaft mechanism and a key module; and

FIG. 22 is a schematic diagram illustrating an exemplary cross-sectional structure of a loudspeaker component on another cross section perpendicular to a cross section shown in FIG. 20.

### DETAILED DESCRIPTION

The present disclosure is described in further detail below in conjunction with the accompanying drawings and embodiments. In particular, it is noted that the following embodiments are only used to illustrate the present disclosure, but do not limit the scope of the present disclosure. Similarly, the following embodiments are only part of the embodiments of the present disclosure rather than all of the embodiments, and all other embodiments obtained by a person of ordinary skill in the art without creative labor fall within the scope of protection of the present disclosure.

References to “embodiments” in the present disclosure imply that particular features, structures, or characteristics described in conjunction with embodiments may be included in at least one embodiment of the present disclosure. It is understood by those of skill in the art, both explicitly and implicitly, that the embodiments described in the present disclosure may be combined with other embodiments.

As shown in FIG. a1, an earphone 1 may include a wearing component 2, a loudspeaker component 3, and a stick microphone component 7. A count of the loudspeaker components 3 may be two. The two loudspeaker components 3 are configured to transmit vibration and/or sound to a user's left ear and right ear, respectively. The two loudspeaker components 3 may be the same or different. For example, one of the two loudspeaker components 3 may be provided with the stick microphone component 7, and the other loudspeaker component 3 may not be provided with the stick microphone component 7.

As shown in FIG. a2, the wearing component 2 may include a headband component 21, a telescopic component 22, and a torsion component 23. A count of the telescopic components 22 may be two, and a count of the torsion components 23 may be two. Two ends of the headband component 22 are connected one-to-one to the two telescopic components 21, and the two telescopic components 22 are connected one-to-one to the two torsion components 23. The two torsion components 23 are connected one-to-one to the two loudspeaker components 3. The headband component 21 is configured to be wound around the top of the user's head, and the shape of the headband component 21 may be matched with the contour of the user's head, which makes the user more comfortable and the earphone more stable when the headband component 21 is worn. The headband component 21 is further configured to elastically clamp two sides of the user's head. The telescopic component 22 can perform telescopic movement to adjust its length, thereby changing the distance between the headband component 21 and the loudspeaker component 3, which allows adaptive adjustment based on different user head shapes, enabling the loudspeaker component 3 to be placed at a suitable position, thus improving the compatibility of the wearing component 2. The torsion component 23 can generate elastic torsion, and can generate torsion when the loudspeaker component 3 contacts the user's head in the wearing state, which enables the loudspeaker component 3 to better conform to the user's face or be accurately placed at the ear.

As shown in FIG. a2, the headband component 21 may include a clamping component 210 and a first elastic wrapping body 212. The clamping component 210 may include an elastic sheet that may realize an elastic clamping function. The first elastic wrapping body 212 may include a wrapping main body 2121 and an elastic band 2122 integrally molded with the wrapping main body 2121. The wrapping main body 2121 is molded to enclose the outer periphery of the clamping component 210 and a wire. Two ends of the elastic band 2122 are spaced apart from each other along a length direction of the clamping component 210 and are respectively connected to the wrapping main body 2121. The elastic band 2122 and the wrapping main body 2121 are separated from each other between connection positions of the two ends of the elastic band 2122 and the wrapping main body 2121. The elastic band 2122 is configured to assist in placing the clamping component 210 onto the user's head when the wearing component 2 is in a wearing state.

As shown in FIG. a2, the telescopic component 22 may include a fixing portion 221 and a telescopic portion 223 that is telescopic relative to the fixing portion 221, and two ends of the clamping component 210 are fixed with the corresponding fixing portion 221, respectively. For example, the two ends of the clamping component 210 may be plugged into the corresponding fixing portion 221. The telescopic component 22 may include a decorative portion 224. The fixing portion 221 is provided with a sliding groove 2203, the telescopic portion 223 is slidably disposed in the sliding groove 2203. The decorative portion 224 is assembled and fixed (e.g., capped to each other) with the fixing portion 221 to cover the sliding groove 2203 and a portion of the telescopic portion 223 located within the sliding groove 2203.

As shown in FIG. a2, the torsion component 23 may include an elastic connecting member 231, a second elastic wrapping body 232, and a first plug-in portion 233 and a second plug-in portion 234 disposed at two ends of the elastic connecting member 231, respectively. The elastic connecting member 231 is approximately indicated by a dashed line in FIG. a2. The second elastic wrapping body 232 is molded to enclose the outer periphery of the elastic connecting member 231, and the wire may be threaded within the second elastic wrapping body 232. The first plug-in portion 233 is plugged into a plug-in hole 310 of the loudspeaker component 3, and the second plug-in portion 234 is plugged into a plug-in hole (not shown in the figures) of the telescopic portion 223.

As shown in FIG. a2, the loudspeaker component 3 may include a shell component 30, a bone-conduction loudspeaker 40, and an air-conduction loudspeaker 50. The loudspeaker component 3 may further include at least one of a battery 61 or a control circuit board 62. The shell component 30 is configured to accommodate the bone-conduction loudspeaker 40 and the air-conduction loudspeaker 50, the bone-conduction loudspeaker 40 being configured to fit the user's face and the air-conduction loudspeaker 50 being configured to deliver air-conducted sound waves to the user's ear canal. While the earphone 1 is worn on the user's head, the wearing component 2 may place the loudspeaker component 3 in a facial region in front of the user's tragus.

As shown in FIG. a2, the shell component 30 may include a main shell body 31 and a main cover body 32. The main shell body 31 may have an open end, and the main cover body 32 covers the open end of the main shell body 31. The main cover body 32 may be provided with a sound outlet hole (not shown in the figures) for the air-conduction loudspeaker 50 to produce sound. A portion of the bone-conduction loudspeaker 40 may be exposed through the open end of the main shell body 31 to fit the user's face. Vibration directions of the bone-conduction loudspeaker 40 and the air-conduction loudspeaker 50 may be perpendicular to each other, and the bone-conduction loudspeaker 40 and the air-conduction loudspeaker 50 may be assembled on the main shell body 31 in a manner in which the vibration directions are perpendicular to each other to minimize the mutual interference. The bone-conduction loudspeaker 40 may be provided with an auxiliary face-fitting component 44 for comfort when contacting the user's face. The auxiliary face-fitting component 44 is configured to increase the contact area between the bone-conduction loudspeaker 40 and the user's face in the wearing state to enhance wearing comfort. The auxiliary face-fitting component 44 may include a rigid support member 441 and a soft fitting member 442. The rigid support member 441 is configured to support the soft fitting member 442 to improve the structural strength and stability of the auxiliary face-fitting component 44, the soft fitting member 442 is configured to fit the user's face towards the user's face, and the soft fitting member 442 can fit the user's face more stably and tightly when supported by the rigid support member 441.

As shown in FIG. a2, the loudspeaker component 3 may include at least one of the control circuit board 62 or the battery 61. For example, one of the two loudspeaker components 3 may include the control circuit board 62, and the other loudspeaker component 3 may include the battery 61 instead of the control circuit board 62. A connection wire between the two loudspeaker components 3 may be threaded across the wearing component 2. For example, one of the two loudspeaker components 3 may include both the control circuit board 62 and the battery 61. As another example, a count of the control circuit boards 62 may be two, and each of the two loudspeaker components 3 may include a control circuit board 62. A count of the batteries 61 may also be two, and each of the two loudspeaker components 3 may include a battery 61.

The stick microphone component 7 is disposed on the loudspeaker component 3 in a rotatable manner. In the wearing state, the stick microphone component 7 may include a stick component 70, a microphone component 80, and a rotating shaft mechanism 91. The microphone component 80 and the rotating shaft mechanism 91 may be connected to two ends of the stick component 70, respectively, and the rotating shaft mechanism 91 is rotatably connected to the loudspeaker component 3. In the wearing state, the rotating shaft mechanism 91 may place the microphone component 80 in a sound pickup region near the user's mouth by rotating relative to the loudspeaker component 3. The microphone component 80 is provided with at least one microphone and an associated key, which enables the microphone to be turned on or off.

In the fields of medicine and anatomy, three basic sections of the human body, namely a sagittal plane, a coronal plane, and a horizontal plane, as well as three basic axes of the human body, namely a sagittal axis, a coronal axis, and a vertical axis, may be defined. The sagittal plane refers to a section along an anterior-posterior direction of the body and perpendicular to the ground, which divides the body into left and right portions; the coronal plane refers to a section along a left-right direction of the body and perpendicular to the ground, which divides the body into front and back portions; and the horizontal plane refers to a section along an up-down direction of the body and parallel to the ground, which divides the human body into upper and lower portions. Correspondingly, the sagittal axis SA refers to an axis along the anterior-posterior direction of the body and perpendicular to the coronal plane, the coronal axis refers to an axis along the left-right direction of the body and perpendicular to the sagittal plane, and the vertical axis VA refers to an axis along the upper-lower direction of the body and perpendicular to the horizontal plane. As shown in FIG. a3, when the earphone 1 is in the wearing state, the wearing assembly 2 is clamped on two sides of the user's head, and the speaker component 3 is located in a face region in front of the tragus along the sagittal axis SA.

The following contents will describe in detail the earphone 1 or some of the above mentioned components, structures, etc., and it should be understood that, some of the above mentioned structures, components, such as the bone-conduction loudspeaker 40, the air-conduction loudspeaker 50, etc., can be used not only on the earphone 1, but also on other electronic devices, such as a cell phone, a speaker, a smart wearable device, or the like.

The following describes an exemplary structure of the earphone 1 according to embodiments of the present disclosure.

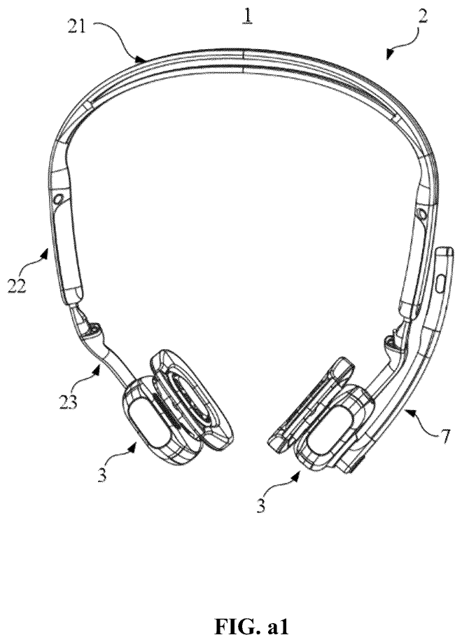

As shown in FIG. 1 to FIG. 4, in some embodiments, the earphone 1 includes the wearing component 2 and the loudspeaker component 3 connected to the wearing component 2. The wearing component 2 is configured to, in the wearing state, place the loudspeaker component 3 in the facial region in front of the user's tragus. In front of the tragus refers to the side of the tragus near the nose.

The loudspeaker component 3 in the facial region in front of the user's tragus can deliver sound to the user's ear through a loudspeaker. A count of the loudspeaker components 3 may be two. The two loudspeaker components 3 are configured to transmit vibration and/or sound to the user's left ear and right ear, respectively. The two loudspeaker components 3 may be the same or different. Further, the earphone 1 may also include the stick microphone component 7, and the stick microphone component 7 may be disposed on one of the two loudspeaker components 3. The stick microphone component 7 may be configured to trigger the loudspeaker component 3 to operate, and the stick microphone component 7 may also be configured to collect sound. The loudspeaker component 3 may include at least one of a bone-conduction loudspeaker or an air-conduction loudspeaker.

The wearing component 2 may place the loudspeaker component 3 at the facial region in front of the user's tragus, and the wearing component 2 may also apply a force to the loudspeaker component 3 to make the loudspeaker component 3 fit the facial region in front of the user's tragus. Specifically, the wearing component 2 is configured to wrap around the top of the user's head and may cause the loudspeaker component 3 to be located in front of the user's ear. The shape of the wearing component 2 may be matched to the contour of the user's head, which allows the user to wear the earphone 1 more comfortably and stably.

The following is an exemplary structure of the wearing component 2 of the present disclosure.

As shown in FIG. 1 to FIG. 4, the wearing component 2 may include the headband component 21. The headband component 21 includes the clamping component 210, a wire 211b, and the first elastic wrapping body 212. The clamping component 210 has a length direction Lt, a thickness direction Ht, and a width direction Wt, and the clamping component 210 has a curved shape along the length direction Lt, so that the headband component 21 wraps around the top of the user's head in the wearing state and provides a clamping force. The dimension of the clamping component 210 along the width direction Wt is larger than the dimension of the clamping component 210 along the thickness direction Ht, and the thickness direction Ht faces or is away from the user's head when the wearing component 2 is in the wearing state. The first elastic wrapping body 212 includes the wrapping main body 2121, the wrapping main body 2121 is molded to enclose an outer periphery of the clamping component 210 and the wire 211b, and the clamping component 210 and the wire 211b located within the wrapping main body 2121 at least partially overlap along the thickness direction Ht. The clamping component 210 and the wire 211b at least partially overlapping along the thickness direction Ht means that they are at least partially flush with each other along the thickness direction Ht.

Specifically, the clamping component 210 may be deformed under an external force during the wearing process of the headband component 21, and a stress may be generated within the clamping component 210, causing the clamping component 210 to have a clamping effect, which can improve the wearing stability of the headband component 21.

By setting the dimension of the clamping component 210 along the width direction Wt to be larger than the dimension of the clamping component 210 along the thickness direction Ht, the dimension of the clamping component 210 along the thickness direction Ht is smaller, which allows the clamping component 210 to undergo a more stable and directional elastic deformation in the direction of clamping the user's head, and reduces elastic deformation of the clamping component 210 along the width direction Wt, thereby facilitating the molding of the clamping component 210 and the wearing of the headband component 21. The larger dimension of the clamping component 210 along the width direction Wt allows the clamping component 210 to maintain sufficient clamping force, and at the same time facilitates an increase in the action area of the clamping component 210 on the top of the user's head to improve the wearing stability of the headband component 21.

The wrapping main body 2121 may be made of an elastic material and be capable of deformation, so that it can deform in synchronization with the clamping component 210. The wrapping main body 2121 is molded to enclose the outer periphery of the clamping component 210 and the wire 211b such that the assembly process of the headband component 21 can be simplified and the structural stability of the headband component 21 can be improved. The wrapping main body 2121 can also enhance the tactile sensation of the user when contacting the headband component 21, and improve the wearing comfort of the headband component 21. The elastic deformation of the wrapping main body 2121 also increases the friction between the user's head and the headband component 21, reduces the risk of the headband component 21 sliding during wear, and improves wearing stability. For example, the wrapping main body 2121 is molded to enclose the outer periphery of the clamping component 210 and the wire 211b, such as through injection molding or compression molding. The material of the headband component 21 may include silicone, rubber, or the like. For example, the wrapping main body 2121 is made of silicone or rubber.

The mechanical strength of the clamping component 210 is higher than the mechanical strength of the wire 211b. By arranging the clamping component 210 and the wire 211b to at least partially overlap along the thickness direction Ht, the tensile or compressive forces exerted on the wire 211b during deformation of the clamping component 210 can be reduced, thereby extending the service life of the wire 211b. Moreover, the deformation consistency between the clamping component 210 and the wire 211b is improved, thereby enhancing the structural stability of the wearing component 2.

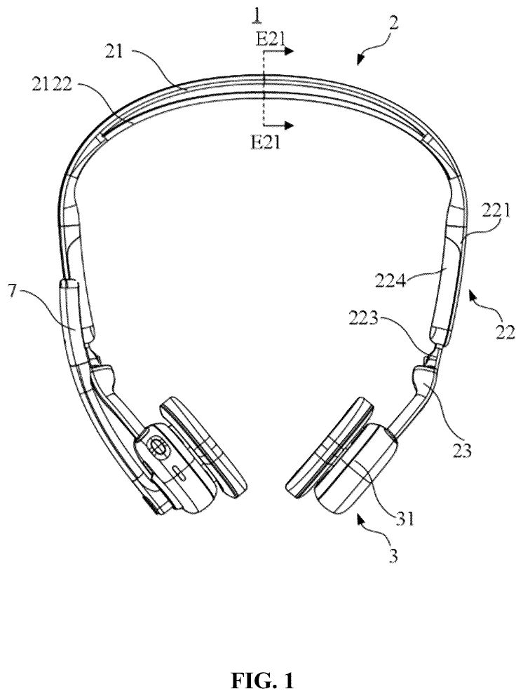

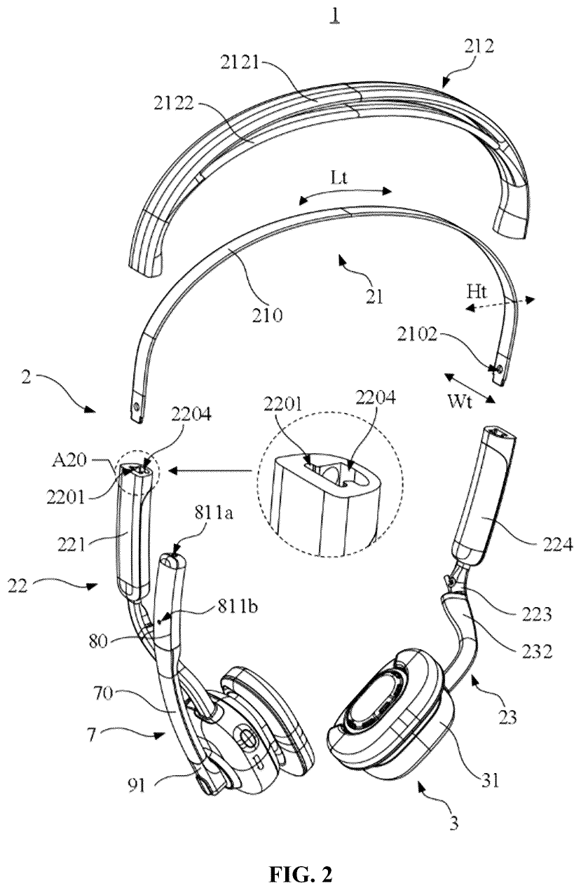

Optionally, as shown in FIG. 4 and FIG. 5, a ratio of an overlapping dimension between the clamping component 210 and the wire 211b along the thickness direction Ht to a smaller one of the dimension of the clamping component 210 along the thickness direction Ht and the dimension of the wire 211b along the thickness direction Ht is in a range from 0.6 to 1. Optimally, the ratio may be in a range from 0.7 to 0.9.

Specifically, in some embodiments, the dimension of the clamping component 210 along the thickness direction Ht is greater than or equal to the dimension of the wire 211b along the thickness direction Ht, and a ratio of the overlapping dimension between the clamping component 210 and the wire 211b along the thickness direction Ht to the dimension of the wire 211b along the thickness direction Ht is in a range from 0.6 to 1. For example, the ratio of the overlapping dimension between the clamping component 210 and the wire 211b along the thickness direction Ht to the dimension of the wire 211b along the thickness direction Ht is 0.7, 0.8, or 0.9.

In other embodiments, the dimension of the clamping component 210 along the thickness direction Ht is less than the dimension of the wire 211b along the thickness direction Ht, and the ratio of the overlapping dimension between the clamping component 210 and the wire 211b along the thickness direction Ht and the dimension of the clamping component 210 along the thickness direction Ht is in a range from 0.6 to 1. For example, the ratio of the overlapping dimension between the clamping component 210 and the wire 211b along the thickness direction Ht to the dimension of the clamping component 210 along the thickness direction Ht is 0.7, 0.8, or 0.9.

In such cases, the clamping component 210 and the wire 211b have more overlap along the thickness direction Ht, which is conducive to the synchronized deformation of the wire 211b and the clamping component 210, and reduces the stretching or squeezing subjected by the wire 211b during the deformation of the clamping component 210, thereby improving the service life of the wire 211b. Moreover, more overlaps between the clamping component 210 and the wire 211b along the thickness direction Ht are conducive to reducing the dimension of the headband component 21 along the thickness direction Ht, thereby thinning the headband component 21 overall. If the ratio is small, the deformation of the clamping component 210 will result in the wire 211b being subjected to too much stretching or squeezing, which is also detrimental to the overall thinning of the headband component 21.

Optionally, as shown in FIG. 4 and FIG. 5, a ratio of the dimension of the clamping component 210 along the thickness direction Ht to the dimension of the wire 211b along the thickness direction Ht is in a range from 0.5 to 2. Optionally, the ratio may be in a range from 0.8 to 1.8. Optionally, the ratio may be in a range from 1.1 to 1.6. For example, the ratio of the dimension of the clamping component 210 along the thickness direction Ht to the dimension of the wire 211b along the thickness direction Ht is 0.7, 0.9, 1.0, 1.2, 1.5, or 1.8. Optionally, the ratio of the dimension of the clamping component 210 along the thickness direction Ht to the dimension of the wire 211b along the thickness direction Ht is in a range from 0.8 to 1.2.

If the ratio is small, the clamping component 210 and the wire 211b have less overlap along the thickness direction Ht, and the deformation of the clamping component 210 will result in the wire 211b being subjected to too much stretching or squeezing. If the ratio is large, it will cause the headband component 21 to be larger and heavier, which will reduce the wearing comfort of the user and is not conducive to thinning the headband component 21 overall. Thus, setting the ratio in a range can make the difference between the dimension of the clamping component 210 along the thickness direction Ht and the dimension of the wire 211b along the thickness direction Ht within a certain reasonable range, which is conducive to improving the deformation consistency of the clamping component 210 and the wire 211b, thereby reducing the force on the wire 211b while ensuring the overall thinness of the headband component 21.

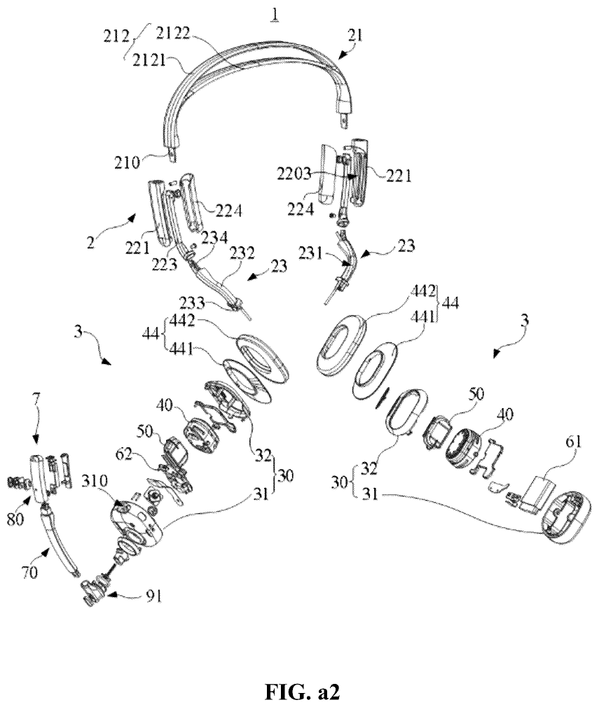

Optionally, as shown in FIG. 1 and FIG. 2, the first elastic wrapping body 212 further includes the elastic band 2122 integrally molded with the wrapping main body 2121. Two ends of the elastic band 2122 are spaced apart from each other along the length direction Lt and are respecively connected to the wrapping main body 2121, and the elastic band 2122 and the wrapping main body 2121 are separated from each other between connection positions of the two ends of the elastic band 2122 and the wrapping main body 2121. The elastic band 2122 is configured to assist in placing the clamping component 210 onto the user's head when the wearing component 2 is in the wearing state.

The stiffness of the clamping component 210 is larger than that of the elastic band 2122, and the bending deformation ability of the clamping component 210 is less than that of the elastic band 2122. The elastic band 2122 is elastic and can easily fit the user's head, which increases the wearing comfort. By setting the elastic band 2122, the headband component 21 can have more degrees of freedom in structure, which enhances its covering effect on the user's head, and in turn increases the friction between the headband component 21 and the user's head, thereby improving the wearing stability of the headband component 21. The material of the elastic band 2122 can also increase the friction between the user's head and the headband component 21, reducing the risk of slippage during wear and improving the wearing stability. In addition, the elastic band 2122 can also provide a clamping force when elastically deformed to enhance the clamping effect of the headband component 21.

By integrally molding the wrapping main body 2121 with the elastic band 2122, the assembly process can be simplified. By setting the elastic band 2122 and the wrapping main body 2121 to be separated from each other, the elastic band 2122 can be more flexible in deformation, and the functional effect of the elastic sheet 2101 can be enhanced. Furthermore, the elastic band 2122 and the wrapping main body 2121 may be separated from each other to provide a space for the deformation of the elastic band 2122, and the elastic band 2122 is closer to the user's head, so as to enhance the wearing stability.

For example, the wrapping main body 2121 is integrally molded with the elastic band 2122 in a molding manner such as injection molding or compression molding. The material of the elastic band 2122 may include silicone, rubber, or the like.

Optionally, as shown in FIG. 4 and FIG. 5, the wearing component 2 is configured to, when the wearing component 2 is in the wearing state, place the loudspeaker component 3 at an ear of the user or a listening region near the ear. Along the sagittal axis SA direction, the loudspeaker component 3 is closer to the face of the user relative to the clamping component 210, and the wire 211b is closer to a rear side of the head relative to the clamping component 210.

In this way, the clamping component 210 can be closer to the loudspeaker component 3 along the sagittal axis SA direction, which is conducive to improving the effect of the clamping component 210 in placing the loudspeaker component 3, and making the wearing of the loudspeaker component 3 more stable. Besides, the wire 211b is closer to the rear side of the head than the clamping component 210, making the clamping component 210 closer to the front side of the head, where the structural strength is higher, which enables the clamping component 210 to clamp the user's head more securely and helps reduce the possibility of the headband component 21 slipping off when the user lowers his/her head.

Optionally, as shown in FIG. 4 and FIG. 5, the clamping component 210 includes the elastic sheet 2101, and the wire 211b is arranged on a side of the elastic sheet 2101 along the width direction Wt and at least partially overlaps with the elastic sheet 2101 along the thickness direction Ht.

In this way, the dimension of the headband component 21 along the thickness direction Ht is reduced, so that the headband component 21 is lightened and thinned. The sheet-like configuration of the elastic sheet 2101 is easy to mold during the manufacturing process, resulting in a high yield rate. The dimension of the elastic sheet 2101 along the width direction Wt may be larger than the dimension of the elastic sheet 2101 along the thickness direction Ht, and by setting the elastic sheet 2101, strain and stress may be generated inside the elastic sheet 2101 during the wearing of the headband component 21, causing the elastic sheet 2101 to have a clamping effect, thereby improving the wearing stability of the headband component 21.

By molding the wrapping main body 2121 to enclose the outer periphery of the elastic sheet 2101 and the wire 211b, the assembly process of the headband component 21 can be simplified, and the structural stability of the headband component 21 can be improved. By setting the elastic sheet 2101 and the wire 211b to at least partially overlap along the thickness direction Ht, the stretching or squeezing subjected by the wire 211b during deformation of the elastic sheet 2101 can be reduced and the elastic sheet 2101 and the wire 211b have a high deformation consistency, which improves the structural stability of the headband component 21, thereby improving the service life of the wire 211b.

Further, the elastic sheet 2101 may be a titanium sheet, or may also be a spring steel sheet, or may be a carbon fiber sheet.

Optionally, the dimension of the elastic sheet 2101 along the thickness direction Ht is in a range from 0.65 mm to 2 mm. Further, the dimension of the elastic sheet 2101 along the thickness direction Ht is in a range from 0.8 to 1.6 mm or in a range from 1.65 to 1.8 mm, e.g., the dimension of the elastic sheet 2101 along the thickness direction Ht is 0.83 mm, 0.85 mm, or 0.87 mm.

If the elastic sheet 2101 has a relatively large dimension along the thickness direction Ht, it will result in the headband component 21 being relatively large and heavy, which reduces the wearing comfort of the user and is not conducive to the lightness of the headband component 21. If the elastic sheet 2101 has a relatively small dimension along the thickness direction Ht, on the one hand, the elastic sheet 2101 fails to provide sufficient clamping force, and on the other hand, it will result in the wire 211b being subjected to excessive stretching or squeezing when the elastic sheet 2101 is deformed. Thus, setting the dimension range, on the one hand, is conducive to the lightness of the headband component 21 and enhancing user comfort during wear, and on the other hand, allows the elastic sheet 2101 to effectively clamp onto the user's head, reducing the tensile or compressive forces exerted on the wire 211b, thereby protecting the wire 211b when the elastic sheet 2101 deforms.

Optionally, a portion of the wire 211b within the wrapping main body 2121 includes a wire bundle, and a dimension of the wire bundle along the thickness direction Ht is in a range from 1 mm to 2.5 mm. For example, the dimension of the wire bundle along the thickness direction Ht is in a range from 1.2 to 2 mm, e.g., the dimension of the wire bundle along the thickness direction Ht is 1.2 mm, 1.3 mm, 1.5 mm, or 1.6 mm.

Optionally, the portion of the wire 211b within the wrapping main body 2121 includes the wire bundle and an insulated wire bundle channel for wrapping the wire bundle. Optionally, the wire bundle is movably wrapped in the insulated wire bundle channel.

If the dimension of the wire 211b along the thickness direction Ht is relatively large, the wire 211b may be susceptible to stretching or squeezing. If the dimension of the wire 211b along the thickness direction Ht is relatively small, the mechanical strength and electrical conductivity of the wire 211b may be reduced. Thus, setting the dimension range is favorable for the wire 211b to maintain a good and stable working condition and extend the service life of the wire 211b.

Further, an exposed portion of the wire 211b is a wire bundle wrapped by an insulating skin, and the thickness of the wire bundle is in a range from 1.6 mm to 2.4 mm, e.g., the thickness of the portion of the wire bundle is 1.8 mm, 2 mm, or 2.2 mm. The insulating skin provides insulation and aesthetic effects. Setting up in this way can make the thickness of the insulating skin moderate and can improve the working stability of the insulating skin. If the insulating skin is too thin, it may be prone to damage; if it is too thick, it can lead to material waste and negatively affect the overall appearance.

Optionally, during the assembly process, the wire 211b and the elastic sheet 2101 may be glued to enable the wire 211b to be shaped, after which the wrapping main body 2121 may wrap the wire 211b and the elastic sheet 2101.

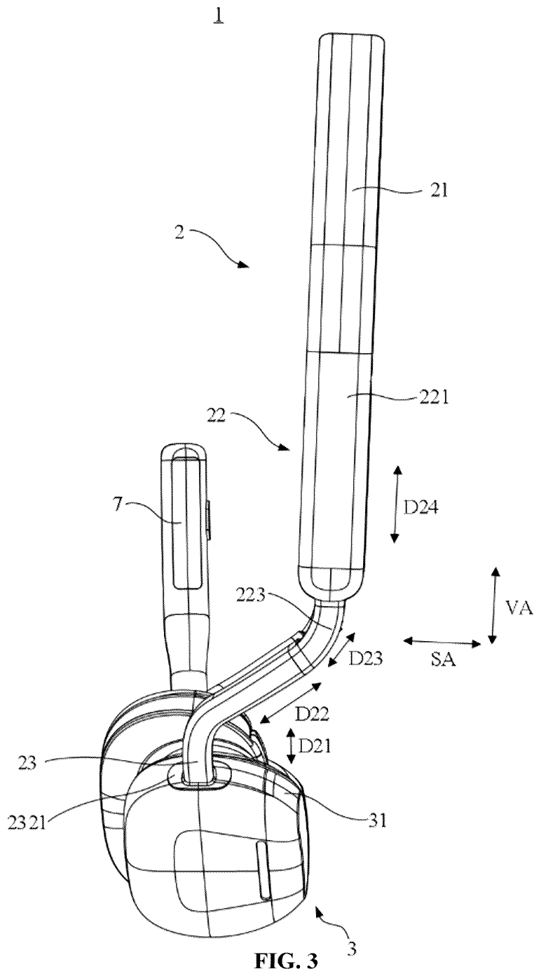

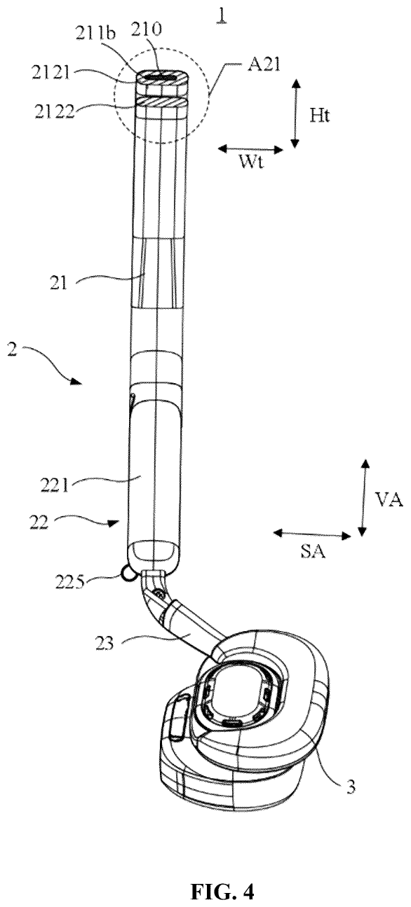

Optionally, as shown in FIG. 4, FIG. 6, and FIG. 7, the clamping component 210 includes two elastic sheets 2101 disposed side-by-side along the width direction Wt. The wire 211b is disposed between the two elastic sheets 2101 or on a side of one elastic sheet 2101 that is away from the other elastic sheet 2101, and at least partially overlaps the two elastic sheets 2101 along the thickness direction Ht, respectively.

The clamping force of the clamping component 210 can be enhanced by providing two elastic sheets 2101, so that the clamping component 210 is easy to deform with sufficient clamping force, thereby improving the wearing effect. The wire 211b is provided between the two elastic sheets 2101 along the width direction Wt or on the side of one elastic sheet 2101 that is away from the other elastic sheet 2101, which provides the clamping component 210 with sufficient support while providing effective protection for the wire 211b due to the increased strength and elastic capacity. Further, if the wire 211b is disposed between the two elastic sheets 2101 along the width direction Wt, the two elastic sheets 2101 may play a role in supporting the frame when the headband component 21 is deformed, thus protecting the wire 211b.

Furthermore, the wire 211b is disposed on a side of the two elastic sheets 2101 that is away from the loudspeaker component 3 along the sagittal axis SA direction, thereby facilitating the clamping component 210 to place the loudspeaker component 3.

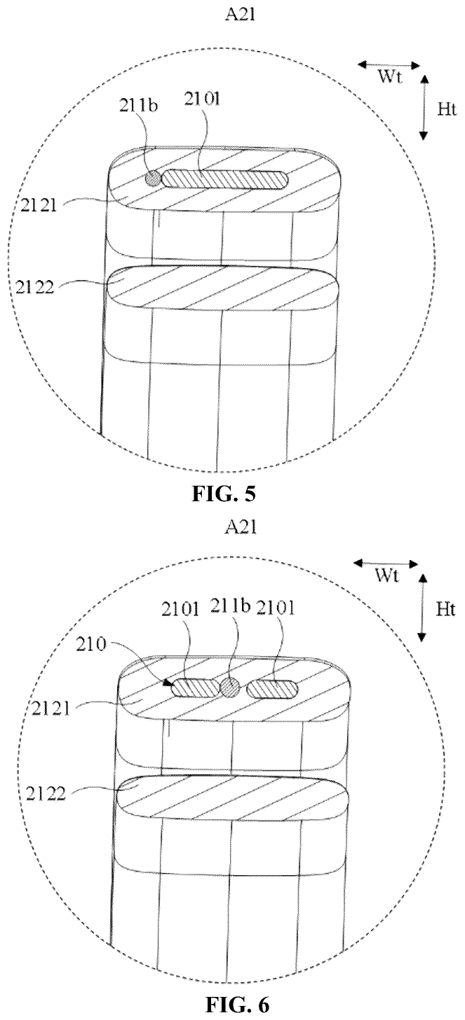

Optionally, as shown in FIG. 4 and FIG. 8, the clamping component 210 includes two elastic sheets 2101 stacked along the thickness direction Ht, and the wire 211b is sandwiched between the two elastic sheets 2101.

By providing the two elastic sheets 2101, the clamping component 210 can be made easy to deform while obtaining sufficient clamping force, thereby improving the wearing effect. When the wire 211b is disposed between the two elastic sheets 2101 along the thickness direction Ht, the two elastic sheets 2101 can play a role in supporting the frame when the headband component 21 is deformed, thereby protecting the wire 211b, which is conducive to improving the structural stability of the headband component 21.

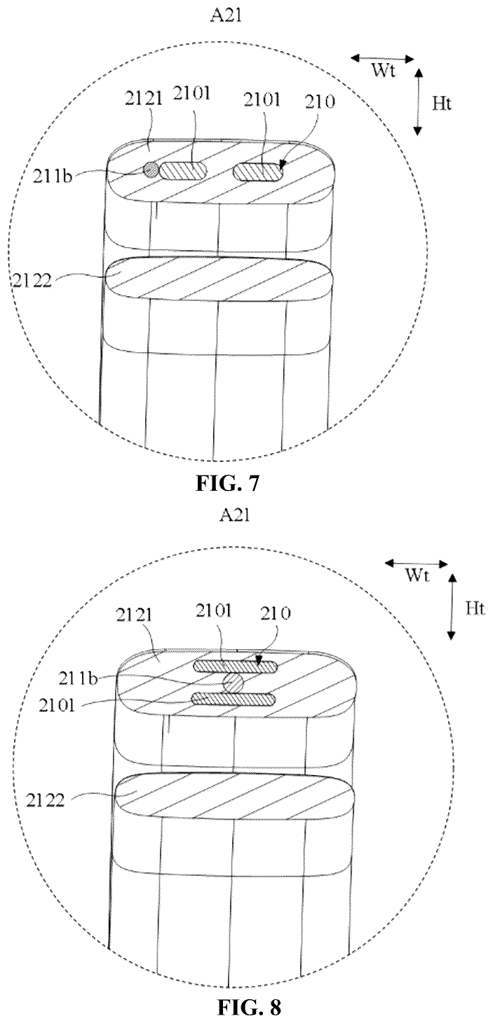

Optionally, as shown in FIG. 1 and FIG. 9, two ends of the clamping component 210 are exposed from the first elastic wrapping body 212, and the wearing component 2 further comprises the telescopic component 22, the telescopic component 22 being assembled and fixed to the clamping component 210 through exposed end portions of the first elastic wrapping body 212.

The telescopic component 22 may be connected between the loudspeaker component 3 and the headband component 21, and the telescopic component 22 is telescopic under the action of an external force, allowing its length to change accordingly, which changes the distance between the loudspeaker component 3 and the headband component 21. By setting the telescopic component 22, the structure of the wearing component 2 is more flexible. When different users wear the earphone 1, the wearing component 2 can adaptively adjust according to the user's head shape to position the loudspeaker component 3 appropriately, thereby enhancing the compatibility of the wearing component 2.

The stiffness and hardness of the clamping component 210 are larger than that of the first elastic wrapping body 212, and by setting the telescopic component 22 to be assembled and fixed to the clamping component 210 through the exposed end portions of the first elastic wrapping body 212, the assembly connection of the telescopic component 22 and the headband component 21 can be facilitated, and the connection effect can be improved.

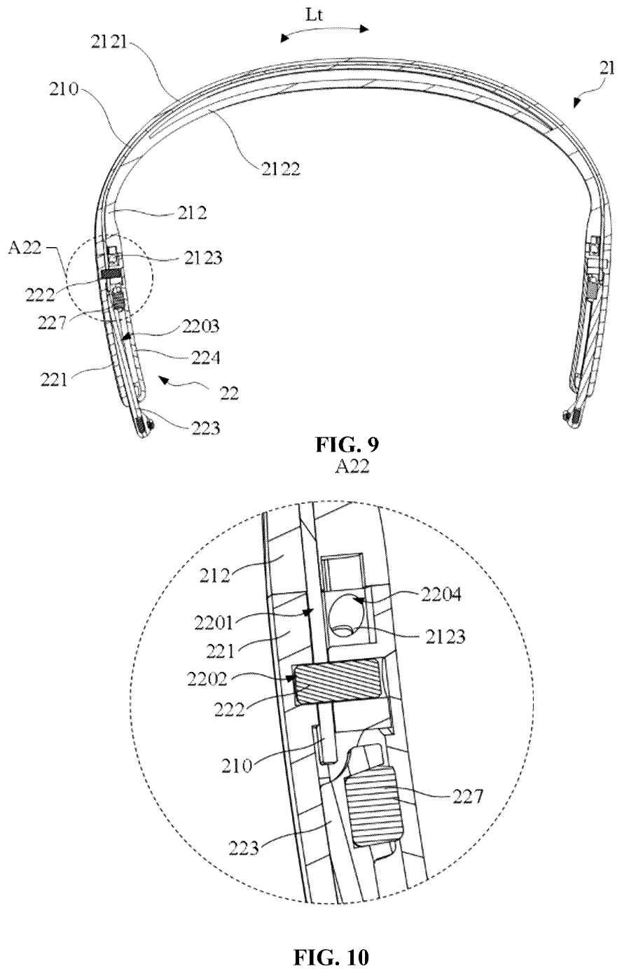

Optionally, as shown in FIG. 1, FIG. 9 to FIG. 11, the telescopic component 22 includes the fixing portion 221, a locking member 222, and the telescopic portion 223. The fixing portion 221 is provided with a first plug-in hole 2201 and a first locking hole 2202 in communication with the first plug-in hole 2201, an end portion of the clamping component 210 is inserted into the first plug-in hole 2201, and the locking member 222 is inserted into the first locking hole 2202 and locks the end portion of the clamping component 210 within the first plug-in hole 2201.

In some embodiments, the telescopic portion 223 may extend and retract to change the length of the telescopic component 22. In other embodiments, the telescopic portion 223 may move relative to the fixing portion 221 to change the length of the telescopic component 22.

In this way, the assembly connection of the clamping component 210 and the telescopic component 22 can be facilitated. For example, during assembly, the end portion of the clamping component 210 may be inserted into the first plug-in hole 2201, and then the locking member 222 may be inserted into the first locking hole 2202. As another example, the end portion of the clamping component 210 may be deformed to be inserted into the first plug-in hole 2201 by snapping.

Optionally, as shown in FIG. 1, FIG. 9 to FIG. 11, the telescopic component 22 further includes the decorative portion 224, the fixing portion 221 is provided with a sliding groove 2203, and the telescopic portion 223 is slidably disposed in the sliding groove 2203. The first locking hole 2202 and the sliding groove 2203 are provided on a side of the fixing portion 221 facing the user when the wearing component 2 is in the wearing state, and the decorative portion 224 is assembled and fixed with the fixing portion 221 to cover the first locking hole 2202, the sliding groove 2203, and a portion of the telescopic portion 223 located within the sliding groove 2203.

The telescopic portion 223 may move relative to the fixing portion 221 along an extension direction of the sliding groove 2203. The decorative portion 224 may obscure the first locking hole 2202, the sliding groove 2203, and the portion of the telescopic portion 223 located within the sliding groove 2203 to serve as an embellishment. The decorative portion 224, when assembled with the fixing portion 221, may also serve as a restriction to limit the locking member 222 from sliding out of the first locking hole 2202 and to limit the telescopic portion 223 from sliding out of the sliding groove 2203.

Optionally, as shown in FIG. 1, FIG. 9 to FIG. 11, the telescopic component 22 further includes a damping member 227, the damping member 227 being fixed to a portion of the telescopic portion 223 located within the sliding groove 2203, and the damping member 227 abuts against the decorative portion 224. The telescopic portion 223 is slidable under an external force, and the damping member 227 is used to increase the sliding resistance of the telescopic portion 223 when it moves between the decorative portion 224 and the fixing portion 221, thereby allowing the telescopic portion 223 to remain in an adjusted position after sliding. Further, the damping member 227 is embedded in the portion of the telescopic portion 223 located within the sliding groove 2203.

Optionally, as shown in FIG. 1, FIG. 9 to FIG. 11, the end portion of the clamping component 210 has a sheet-like shape and is provided with a second locking hole 2102 passing through main surfaces on two sides of the end portion of the clamping component 210. The first locking hole 2202 and the second locking hole 2102 are aligned when the end portion of the clamping component 210 is inserted into the first plug-in hole 2201, and the locking member 222 is a pin inserted into the first locking hole 2202 and the second locking hole 2102. The first elastic wrapping body 212 further comprises an embedding portion 2123 integrally molded with the wrapping main body 2121. The embedding portion 2123 is attached to the main surface on one side of the end portion of the clamping component 210, the fixing portion 221 is provided with a second plug-in hole 2204 in communication with the first plug-in hole 2201, and the embedding portion 2123 is inserted into the second plug-in hole 2204.

By setting the end portion of the clamping component 210 as a sheet-like shape, the shape of the end portion of the clamping component 210 can match the shape of a portion of the clamping component 210 located within the wrapping main body 2121, which facilitates the molding of the clamping component 210 and the second locking hole 2102. By providing the locking member 222 as a pin inserted into the first locking hole 2202 and the second locking hole 2102, the end portion of the clamping component 210 and the fixing portion 221 can be connected more firmly.

By attaching the embedding portion 2123 to the main surface on one side of the end portion of the clamping component 210, the embedding portion 2123 can restrict relative movement between the end portion of the clamping component 210 and the fixing portion 221 along a direction perpendicular to the main surface of the end portion of the clamping component 210, and the embedding portion 2123 can also limit the deformation of the end portion of the clamping component 210, which reduces the risk of fracture of the end portion of the clamping component 210, thereby enhancing the stability of the connection structure between the end portion of the clamping component 210 and the fixing portion 221.

For example, the wrapping main body 2121 is integrally molded with the embedding portion 2123 in a molding manner such as injection molding or compression molding.

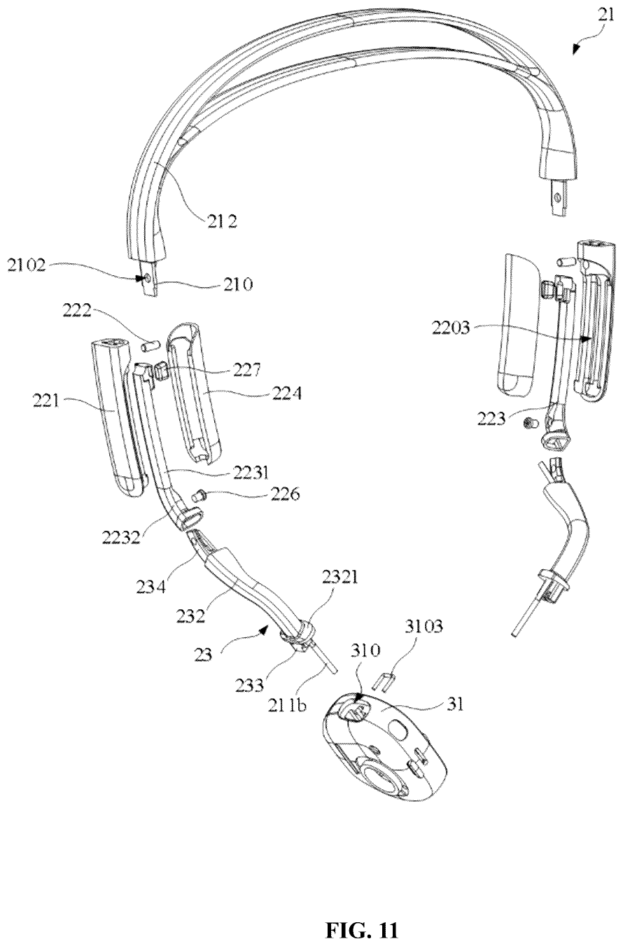

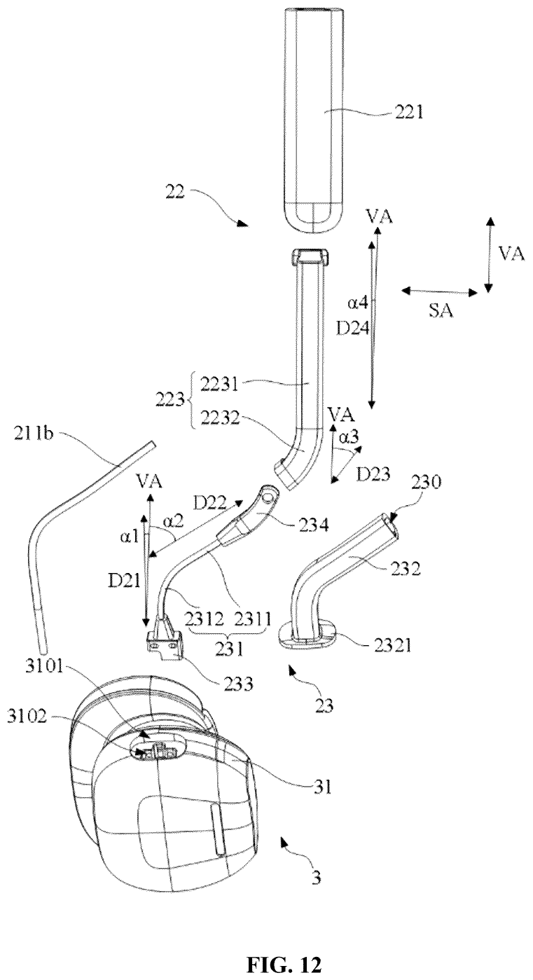

Optionally, as shown in FIG. 1, FIG. 11, and FIG. 12, the telescopic component 22 includes the fixing portion 221 and the telescopic portion 223 that is telescopic relative to the fixing portion 221, and the wearing component 2 further comprises the torsion component 23. The torsion component 23 includes the elastic connecting member 231, one end of the elastic connecting member 231 is connected to the telescopic portion 223, and the other end of the elastic connecting member 231 is connected to the loudspeaker component 3. The elastic connecting member 231 is configured to undergo torsion as the loudspeaker component 3 contacts the head of the user when the wearing component 2 is in the wearing state.

By providing the elastic connecting member 231 connecting the telescopic component 22 and the loudspeaker component 3, the loudspeaker component 3 can have more movement freedom relative to the headband component 21, and the loudspeaker component 3 can better fit the user's head by moving relative to the headband component 21, thereby improving the wearing comfort. After adjusting the position of the telescopic portion 223 relative to the fixing portion 221, the loudspeaker component 3 may move relative to the telescopic portion 223 to better fit the user's head, thereby improving the compatibility of the wearing component 2 with different users.

Optionally, the elastic connecting member 231 is an elastic metal wire as shown in FIG. 12.

In this way, the elastic connecting member 231 can have good structural strength and fatigue resistance to improve its service life. For example, the elastic metal wire may be a titanium wire.

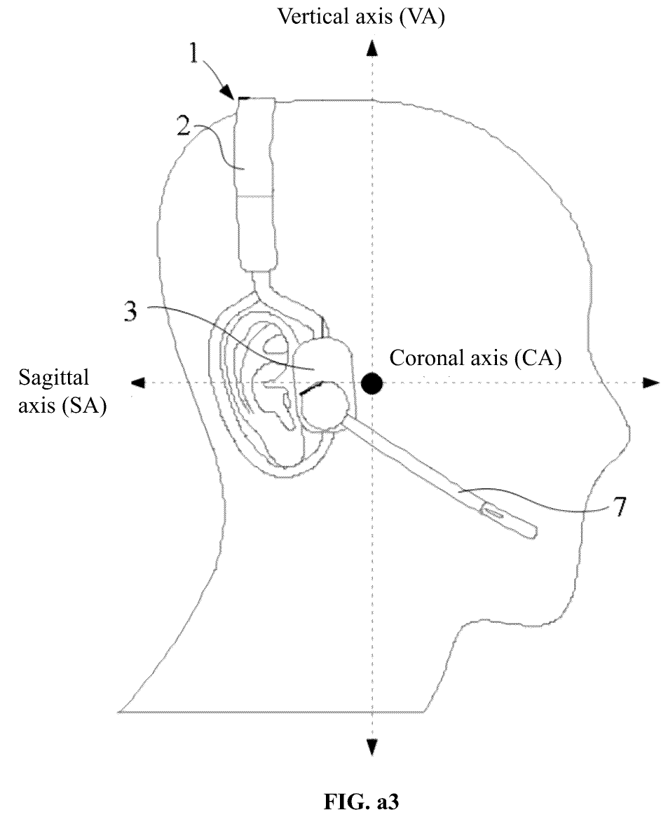

Optionally, as shown in FIG. 3, FIG. 11, and FIG. 12, the wire 211b extends from an outside of the telescopic component 22 to the torsion component 23 and is fixed to the torsion component 23, and a length of the wire 211b outside the telescopic component 22 is greater than a maximum extension amount of the telescopic component 22.

Compared with setting the wire 211b inside the telescopic component 22, setting the wire 211b outside the telescopic component 22 can prevent the telescopic component 22 from interfering with the wire 211b during extension and retraction, reduce the dimension of the telescopic component 22, and enhance the overall aesthetic appearance and contribute to the lightweight design of the earphone.

The torsion component 23 guides the wire 211b to the inside of the loudspeaker component 3. By fixing the wire 211b to the torsion component 23, the torsion component 23 may limit the wire 211b, thereby facilitating the position of the wire 211b inside the loudspeaker to remain stable. For example, this can reduce the interference on the position of the wire 211b inside the loudspeaker component 3 caused by the extension and retraction of the telescopic component 22.

The maximum extension amount of the telescopic component 22 refers to the length of the telescopic component 22 when it is fully extended. By setting the length of the wire 211b outside the telescopic component 22 to be greater than the maximum extension amount of the telescopic component 22, tension on the wire 211b during extension and retraction can be reduced, which not only improves the lifespan of the wire 211b but also minimizes interference of the wire 211b to the telescopic movement of the telescopic component 22.

Further, an aperture is provided at one end of the telescopic component 22 connected to the torsion component 23, and the wire 211b extends from outside the telescopic component 22 into the aperture, and then extends through the aperture into the torsion component 23.

Optionally, as shown in FIG. 3, FIG. 11, and FIG. 12, the torsion component 23 includes the second elastic wrapping body 232. The second elastic wrapping body 232 encloses the outer periphery of the elastic connecting member 231 and is provided with a wiring channel 230, and the wire 211b passes through the wiring channel 230.

The second elastic wrapping body 232 may partially or wholly wrap the torsion component 23. The second elastic wrapping body 232 can deform and undergo torsion in synchronization with the elastic wire. By molding the second elastic wrapping body 232 to enclose the outer periphery of the elastic connecting member 231, the tactile sensation of the torsion component 23 can be improved, the exposed length of the wire 211b can be reduced, and the overall appearance of the torsion component 23 can be improved.

The wire 211b may extend into the inside of the loudspeaker component 3 through the torsion component 23, and by providing the wiring channel 230, the torsion component 23 may limit the wire 211b, which is conducive to maintaining the position of the wire 211b inside the loudspeaker stable.

For example, the second elastic wrapping body 232 encloses the outer periphery of the elastic connecting member 231 through injection molding or compression molding, and forms the wiring channel 230.

The following is an exemplary structure of the wearing component 2 of the present disclosure.

As shown in FIG. 2, FIG. 11, and FIG. 12, in some embodiments, the wearing component 2 comprises the headband component 21 and the torsion component 23, the headband component 21 includes the clamping component 210, and the clamping component 210 has a curved shape along the length direction Lt, so that the headband component 21 is wound around a top the user's head and provides a clamping force when the wearing component 2 is in a wearing state. The torsion component 23 includes the elastic connecting member 231, the elastic connecting member 231 includes a first connecting segment 2311 and a second connecting segment 2312 connected to each other, a free end of the first connecting segment 2311 is connected to the clamping component 210, and a free end of the second connecting segment 2312 is connected to the loudspeaker component 3 to place the loudspeaker component 3 at an ear of the user or a listening region near the ear when the wearing component 2 is in the wearing state. Starting from the free end of the first connecting segment 2311, the first connecting segment 2311 has an extension component extending toward a front side of a face of the user along a sagittal axis, and the second connecting segment 2312 has an extension component extending away from the top of the head along a vertical axis. The elastic connecting member 231 is configured to undergo torsion as the loudspeaker component 3 contacts the head of the user when the wearing component 2 is in the wearing state.

The free end of the first connecting segment 2311 is an end of the first connecting segment 2311 away from the second connecting segment 2312, and the free end of the second connecting segment 2312 is an end of the second connecting segment 2312 away from the first connecting segment 2311. Specifically, the clamping component 210 plays the role of supporting and shaping the headband component 21, and by setting the clamping component 210 to have a curved shape along the length direction Lt, the shape of the headband component 21 can match the contour of the user's head, enabling the user to wear the headband component 21 more comfortably and stably. During the wearing process of the headband component 21, the clamping component 210 can be deformed under the action of an external force, and stress can be generated inside the clamping component 210, which makes the clamping component 210 have a clamping effect, thereby improving the wearing stability of the headband component 21.

By providing the elastic connecting member 231 connecting the clamping component 210 and the loudspeaker component 3, the loudspeaker component 3 can have more freedom of movement. When placed at the facial region, the loudspeaker component 3 can undergo torsion relative to the headband component 21 through the elastic connecting member 23 to better conform to the user's face and adapt to different head and face shapes, thereby enhancing wearing comfort and improving the earphones' compatibility with head shapes and face shapes of various users.

By setting the first connecting segment 2311 to have the extension component extending toward the front side of the face of the user along the sagittal axis, and the second connecting segment 2312 to have the extension component extending away from the top of the head along the vertical axis, on the one hand, the loudspeaker component 3 can be placed at the ear or the listening region near the user's ear, making the loudspeaker component 3 more stable and providing a better sound effect; on the other hand, the above-mentioned connecting structure is simple in design and allows the first connecting segment 2311 and the second connecting segment 2312 to undergo torsion along different directions independently, which enables the elastic connecting member 231 to have more freedom of movement and enhanced torsional deformation capability, allowing the loudspeaker component 3 to better adapt to the user's head and facial contours. As a result, the loudspeaker component 3 can more effectively conform to the user's ear or the listening region near the ear for optimal audio reception, thereby simplifying the structural design of the elastic connecting member 231.

In some embodiments, the first connecting segment 2311 may undergo torsion around a sagittal axis SA such that the loudspeaker component 3 rotates around the sagittal axis SA, and the second connecting segment 2312 may undergo torsion around a vertical axis VA such that the loudspeaker component 3 rotates around the vertical axis VA, to allow the loudspeaker component 3 to have more freedom of movement.

Optionally, as shown in FIG. 2, FIG. 11, and FIG. 12, the second connecting segment 2312 is connected to the first connecting segment 2311 at an obtuse angle, and when the wearing component 2 is in the wearing state, an angle α1 between the second connecting segment 2312 and the vertical axis VA is smaller than an angle α2 between the first connecting segment 2311 and the vertical axis VA.

In this way, an extension path of the elastic connecting member 231 from the clamping component 210 to the loudspeaker component 3 can avoid interfering with the user's ear to improve wearing comfort, and the loudspeaker component 3 is closer to the front side of the user's face along the sagittal axis SA compared with the headband component 21. As a result, when the loudspeaker component 3 is placed at the ear or the listening region near the user's ear for audio reception, the headband component 21 can still rest on the top of the user's head in a stable position, which improves both the wearing stability of the wearing component 2 and the placement accuracy of the loudspeaker component 3.

An extension direction D22 of the first connecting segment 2311 and an extension direction D21 of the second connecting segment 2312 are different, so that the first connecting segment 2311 and the second connecting segment 2312 can undergo torsion along different directions, and the elastic connecting member 231 thereby has more freedom of movement, enhancing the torsional deformation capacity of the elastic connecting member 231 and facilitating the adjustment of the position of the loudspeaker component 3. In some embodiments, the angle α2 between the first connecting segment 2311 and the vertical axis VA is larger, which facilitates the loudspeaker component 3 to adjust its position by rotating around the sagittal axis SA. The angle α1 between the second connecting segment 2312 and the vertical axis VA is smaller, which facilitates the loudspeaker component 3 to adjust its position by rotating around the vertical axis VA.

Optionally, as shown in FIG. 2, FIG. 11, and FIG. 12, the wearing component 2 comprises the telescopic component 22, and the telescopic component 22 includes the fixing portion 221 and the telescopic portion 223. The fixing portion 221 is connected to an end portion of the clamping component 210, the telescopic portion 223 is telescopic relative to the fixing portion 221, and the free end of the first connecting segment 2311 is connected to an end of the telescopic portion 223 away from the clamping component 210.

The telescopic component 22 is connected between the loudspeaker component 3 and the headband component 21, and the telescopic component 22 may extend and retract under external force to change its length, thereby causing a change in the distance between the loudspeaker component 3 and the headband component 21. By setting the telescopic component 22, the structure of the wearing component 2 is more flexible, and when different users wear the earphone 1, the wearing component 2 can be adaptively adjusted according to variations in head shape and size, allowing the loudspeaker component 3 to be placed at a suitable position, thereby enhancing the compatibility of the wearing component 2.

Optionally, as shown in FIG. 2, FIG. 11, and FIG. 12, the fixing portion 221 is provided with the sliding groove 2203, and the telescopic portion 223 includes a first telescopic segment 2231 and a second telescopic segment 2232. The first telescopic segment 2231 is slidably disposed in the sliding groove 2203, the second telescopic segment 2232 is connected to the first telescopic segment 2231 at an obtuse angle, and when the wearing component 2 is in the wearing state, an angle α3 between the second telescopic segment 2232 and the vertical axis VA is larger than an angle α4 between the first telescopic segment 2231 and the vertical axis VA, and the free end of the first connecting section 2311 is connected to a free end of the second telescopic segment 2232.

By disposing the second telescopic segment 2232 to be connected to the first telescopic segment 2231 at an obtuse angle, the telescopic portion 223 may have a streamlined structure, which allows for a smooth transition between the second telescopic segment and the first telescopic segment, thereby enhancing the overall aesthetic appeal of the structure.

The telescopic portion 223 can move relative to the fixing portion 221 along an extension direction of the sliding groove 2203. An extension direction D24 of the first telescopic segment 2231 may be consistent with the extension direction of the sliding groove 2203 to allow the telescopic segment 223 to slide along the extension direction of the sliding groove 2203. An extension direction D23 of the second telescopic segment 2232 may be close to or consistent with the extension direction D22 of the first connecting segment 2311 so that the free end of the first connecting segment 2311 and the free end of the second telescopic segment 2232 can be aligned and connected.

By setting the angle α3 between the second telescopic segment 2232 and the vertical axis VA to be larger than the angle α4 between the first telescopic segment 2231 and the vertical axis VA, the angle α4 between the first telescopic segment 2231 and the vertical axis VA may be relatively small and the angle α3 between the second telescopic segment 2232 and the vertical axis may be relatively large. Since the angle α4 between the first telescopic segment 2231 and the vertical axis VA is relatively small, the loudspeaker component 3 may generate a large displacement along the vertical axis VA when the telescopic portion 223 is sliding relative to the fixing portion 221, thereby enabling greater compatibility with the user's head and facial shape. Since the angle α3 between the second telescopic segment 2232 and the vertical axis VA is relatively large, the second telescopic segment 2232 may generate an extension component along the sagittal axis SA, thereby facilitating placing the loudspeaker component 3 at the user's ear or the listening region near the ear. Specifically, the loudspeaker component 3 is closer to the front side of the user's face along the sagittal axis SA compared to the headband component 21, and the angle α3 between the second telescopic segment 2232 and the vertical axis VA may enable the second telescopic segment 2232 to have a relatively large extension component along the sagittal axis SA, which is conducive to realizing the connection between the loudspeaker component 3 and the headband component 21 along the sagittal axis SA.

In some embodiments, the angle α2 between the first connecting segment 2311 and the vertical axis VA is relatively large, an angle between the fixing portion 221 and the vertical axis VA is relatively small, and by setting the angle α3 between the second telescopic segment 2232 and the vertical axis VA larger than the angle α3 between the first telescopic segment 2231 and the vertical axis VA, the assembly connection between the telescopic portion 223 and the fixing portion 221 and the elastic connecting member 231 can be facilitated.

Optionally, as shown in FIG. 4, FIG. 11, and FIG. 12, the headband component 21 further includes the wire 211b and the first elastic wrapping body 212, the first elastic wrapping body 212 includes the wrapping main body 2121, the wrapping main body 2121 is molded to enclose the outer periphery of the clamping component 210 and the wire 211b, two ends of the wire 211b extend from the wrapping main body 2121, the wire 211b extends from an outside of the telescopic component 22 to the torsion component 23 and is fixed to the torsion component 23, and the length of the wire 211b outside the telescopic component 22 is greater than a maximum extension amount of the telescopic component 22. The wire 211b illustrated in FIG. 11 and FIG. 12 illustrates only one segment of the wire 211b, and does not limit the shape and length of the wire 211b.

A telescopic component 22 is connected to each end of the headband component 21. The wrapping main body 2121 can limit and protect the wire 211b, and guide the wire 211b to extend from an outside of one telescopic component 22 to an outside of another telescopic component 22. As compared to setting the wire 211b inside the telescopic component 22, setting the wire 211b outside the telescopic component 22 can prevent the telescopic component 22 from interfering with the wire 211b during extension and retraction while reducing the dimension of the telescopic component 22 to improve the aesthetics.

The torsion component 23 may guide the wire 211b to the inside of the loudspeaker component 3. By fixing the wire 211b to the torsion component 23, the torsion component 23 may limit the wire 211b, thereby facilitating the wire 211b inside the loudspeaker to remain stable. For example, the interference of the telescopic component 22 on the position of the wire 211b inside the loudspeaker component 3 during extension and retraction may be reduced.

Optionally, as shown in FIG. 11 and FIG. 12, the torsion component 23 further includes the first plug-in portion 233 and the second plug-in portion 234 disposed at two ends of the elastic connecting member 231, respectively, the first plug-in portion 233 is plugged into the loudspeaker component 3, and the second plug-in portion 234 is plugged into the free end of the second telescopic segment 2232.

The first plug-in portion 233 and the second plug-in portion 234 may position two ends of the elastic connecting member 231. By providing the first plug-in portion 233 and the second plug-in portion 234, the assembly structure can be simplified, which facilitates the connection of the elastic connecting member 231 with the loudspeaker component 3 and the telescopic component 22, thereby improving assembly efficiency. Further, the second plug-in portion 234 is inserted into the interior of the free end of the second telescopic segment 2232 and fixed to the free end of the second telescopic segment 2232 through a pin or a threaded fastener 226.

Optionally, as shown in FIG. 11 and FIG. 12, the loudspeaker component 3 includes a main shell 31, the main shell 31 is provided with the plug-in hole 310, the second elastic wrapping body 232 and the first plug-in portion 233 are inserted within the plug-in hole 310, and an outlet of the wiring channel 230 is located within the plug-in hole 310.

By inserting the second elastic wrapping body 232 and the first plug-in portion 233 into the plug-in hole 310, the main shell 31 may shield an end portion of the second elastic wrapping body 232 and an end portion of the first plug-in portion 233, thereby improving the aesthetics of the wearing component 2. By locating the outlet of the wiring channel 230 within the plug-in hole 310, on the one hand, the wire 211b can be shielded to improve aesthetics, and on the other hand, it is easy to guide the wire 211b into the loudspeaker for connection during assembly.

Optionally, as shown in FIG. 2, FIG. 11, and FIG. 12, a flange portion 2321 is disposed at the end portion of the second elastic wrapping body 232, and the plug-in hole 310 includes a first hole segment 3101 and a second hole segment 3102 that are in communication with each other. The second hole segment 3102 is closer to the interior of the main shell 31 relative to the first hole segment 3101, and an aperture of the first hole segment 3101 is greater than an aperture of the second hole segment 3102. The flange portion 2321 is inserted into the first hole segment 3101, and a cross-section of the first hole segment 3101 perpendicular to an insertion direction is adapted to a cross-section of the first hole segment 3101. The first plug-in portion 233 protrudes from an end surface of the flange portion 2321 and is inserted into the second hole segment 3102, and the outlet of the wiring channel 230 is located at the end surface of the flange portion 2321.

The flange portion 2321 may enhance the structural strength of the end portion of the second elastic wrapping body 232, and at the same time, the flange portion 2321, when inserted into the first hole segment 3101, may limit the relative displacement between an end portion of the torsion component 23 and the loudspeaker component 3 along an insertion direction.

By protruding the first plug-in portion 233 from the end surface of the flange portion 2321 and inserting it into the second hole segment 3102, it facilitates fixation of the first plug-in portion 233 to the main shell 31 and prevents the torsion component 23 from detaching from the main shell 31, thereby improving the stability of the connection structure between the end portion of the torsion component 23 and the loudspeaker component 3.

Optionally, as shown in FIG. 11 and FIG. 12, a U-shaped inserting member 3103 may be provided within the main shell 31, and the U-shaped inserting member 3103 is inserted into the interior of the first plug-in portion 233 through a hole wall of the second hole segment 3102 to fix the first plug-in portion 233 to the main shell 31.

Optionally, as shown in FIG. 4 and FIG. 11, the telescopic component 22 further includes a retention portion 225 that remains fixed relative to the fixing portion 221, and the wire 211b outside the telescopic component 22 is retained on the retention portion 225.

By providing the retention portion 225, interference of the wire 211b with other portions of the wearing component 2 can be limited, and aesthetics can be improved.

For example, the retention portion 225 is a clip or buckle. As another example, the retention portion 225 is provided with holes, and the wire 211b is threaded through the holes and thereby retained on the retention portion 225.

Optionally, the wire 211b is disposed to move relative to the retention portion 225 as the telescopic portion 223 extends and retracts.

In this way, the wire 211b can move away from the loudspeaker component 3 within the retention portion 225 during the retraction of the telescopic component 22, and the wire 211b can move toward the loudspeaker component 3 within the retention portion 225 during the extension of the telescopic component 22, thereby avoiding pulling the wire 211b during the extension and retraction, reducing the mechanical stress on the wire 211b, and improving the service life of the wire 211b.

The following is an exemplary structure of a stick microphone component 7 and the like of a headphone of the present application.

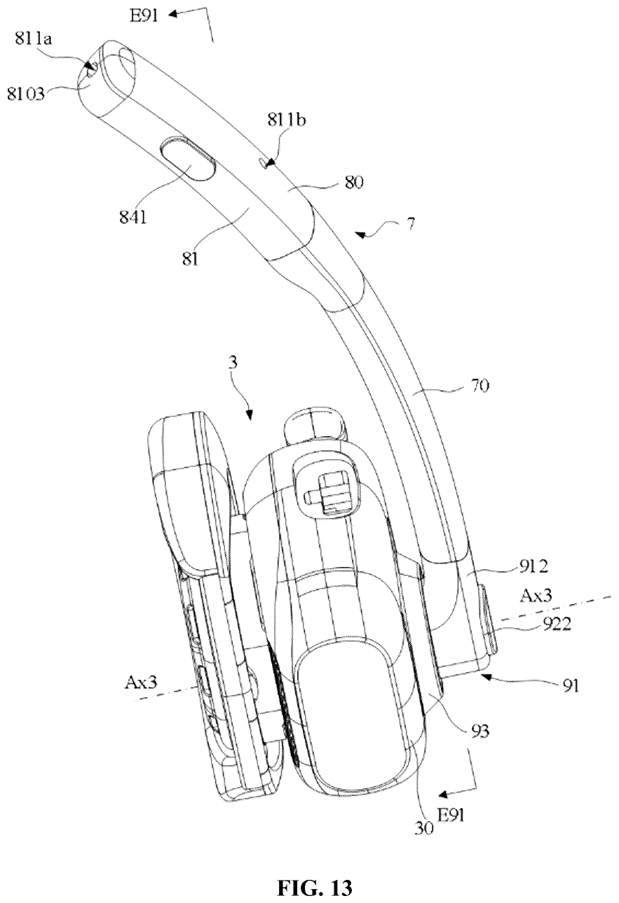

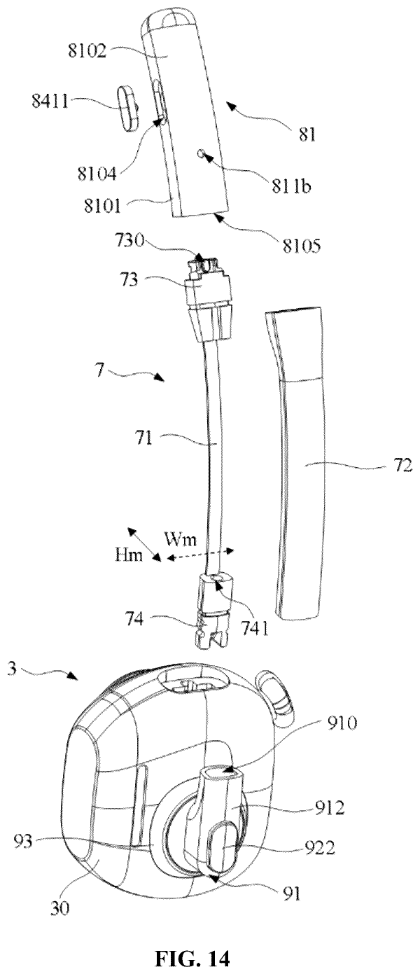

As shown in FIG. 1, FIG. 13, and FIG. 14, in some embodiments, the earphone 1 may include the wearing component 2, the loudspeaker component 3, and the stick microphone component 7. The wearing component 2 is connected to the loudspeaker component 3, and the stick microphone component 7 is rotatably disposed on the loudspeaker component 3 around a preset axis Ax3. The stick microphone component 7 includes a stick component 70 and a microphone component 80. The microphone component 80 is fixedly connected to the stick component 70. The stick component 70 is configured to place the microphone component 80 in a sound pickup region corresponding to the mouth of the user when the earphone 1 is in the wearing state. The stick component 70 includes an elastic sheet 71 and an elastic wrapping body 72, the elastic wrapping body 72 wrapping the elastic sheet 71, the elastic sheet 71 having a thickness direction Hm and a width direction Wm perpendicular to each other, and a dimension of the elastic sheet 71 along the thickness direction Hm is smaller than a dimension of the elastic sheet 71 along the width direction Wm. The thickness direction Hm is disposed toward or away from the user's face in the wearing state.

The loudspeaker component 3 may transmit sound to the human ear. The wearing component 2 may hang the loudspeaker component 3 close to the user's ear, and the wearing component 2 may also apply a force to the loudspeaker component 3 to make the loudspeaker component 3 fit on the facial region close to the user's ear. Specifically, the wearing component 2 is used to wrap around the top of the user's head and cause the loudspeaker component 3 to be located on the front side of the user's ear. The shape of the wearing component 2 can be matched to the contour of the user's head, which makes the user more comfortable and stable when wearing the earphone 1.

The microphone component 80 may collect the user's voice by collecting sounds from the mouth. The stick component 70 may be connected between the microphone component 80 and the loudspeaker component 3, and the microphone component 80 may be controlled to be in different positions and postures by controlling the movement of the stick component 70. For example, when the microphone component 80 is finished using, it can be moved to a stowed position by controlling the movement of the stick component 70 to drive the microphone component 80 away from the sound pickup region and closer to the wearing component 2.

The elastic wrapping body 72 can enhance the tactile sensation of the user's contact with the earphone 1, improving the wearing comfort of the earphone 1. For example, the elastic wrapping body 72 wraps around the elastic sheet 71 by injection molding or compression molding, etc.

During the use of the microphone component 80, the elastic sheet 71 can deform under external force, and the elastic wrapping body 72, which has deformability, can deform synchronously with the elastic sheet 71, thereby making the stick component 70 more structurally flexible. The shape and position of the stick component 70 can be adjusted according to the user's head shape when the earphone 1 is worn by different users, so as to locate the microphone component 80 at a suitable position. Setting up in this way allows the microphone component 80 to have more freedom of movement to collect sound in a more reasonable manner, which can improve the compatibility of the earphone 1 while improving the wearing comfort of the user.

By setting the dimension of the elastic sheet 71 along the thickness direction Hm to be smaller than the dimension of the elastic sheet 71 along the width direction Wm and setting the thickness direction Hm toward or away from the user's face in the wearing state, the elastic sheet 71 may have a relatively smaller dimension HD1 along the thickness direction Hm such that the elastic sheet 71 may deform primarily along the thickness direction Hm, which facilitates adjusting the distances between the stick microphone component 7 and the user's face and mouth to meet different needs for collecting sound, and the elastic sheet 71 may have a relatively large dimension WD1 along the width direction Wm such that the elastic sheet 71 may less prone to deformation along the width direction Wm, allowing a more stable directional elastic deformation along the thickness direction Hm, and the elastic sheet 71 can maintain sufficient supporting and shaping capability, thereby improving the positional stability of the microphone component 80.

Optionally, the stick component 70 can rotate relative to the loudspeaker component 3 around the preset axis Ax3, as shown in FIG. 13 and FIG. 14. The elastic sheet 71 includes two opposite side edges along the width direction Wm and is configured such that, when the stick component 70 rotates around the preset axis Ax3, one of the side edges is in front of the rotation direction, while the other side edge is behind the rotation direction.

By setting the stick component 70 to be rotatable relative to the loudspeaker component 3 around the preset axis Ax3, and due to its large dimension along the width direction Wm, where one side edge of the stick component 70 is in front of and the other side edge is behind the rotation direction, the stick component 70 is less prone to elastic deformation when being pushed along the width direction Wm, which allows the microphone component 80 to rotate directionally around the preset axis Ax3 and have a larger range of movement to meet different sound collection requirements. The stick component 70, by rotating around the preset axis Ax3 relative to the loudspeaker component 3, also allows the microphone component 80 to switch between a stowed position and a working position.

In addition, by setting the elastic sheet 71 such that, when rotating around the preset axis Ax3, one of the two side edges is located in front of the rotation direction and the other is located behind the rotation direction, the rotation direction of the elastic sheet 71 can be inconsistent with the deformation direction, which further expands the degree of freedom and range of movement of the microphone component 80, thereby meeting a wider variety of sound collection requirements.

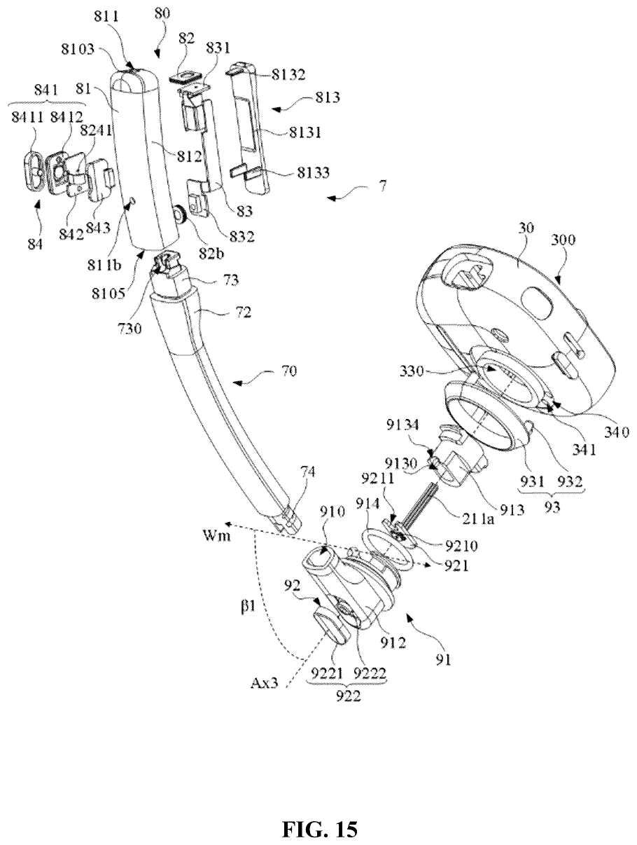

Optionally, as shown in FIG. 15, an angle β1 between the width direction Wm and the preset axis Ax3 is greater than or equal to 80°, and less than or equal to 90°. For example, the angle β1 between the width direction Wm and the preset axis Ax3 is 82°, 84°, 85°, or 87°.

Set up in this way, the rotation direction of the elastic sheet 71 can differ from the deformation direction, which in turn makes the microphone component 80 have a greater range of movement, and the microphone component 80 can have a greater number of postures to meet a wider variety of sound collection requirements. If the angle β1 between the width direction Wm and the preset axis Ax3 is less than 80°, the rotation direction of the elastic sheet 71 is close to the deformation direction, which in turn restricts the range of activity of the microphone component 80.

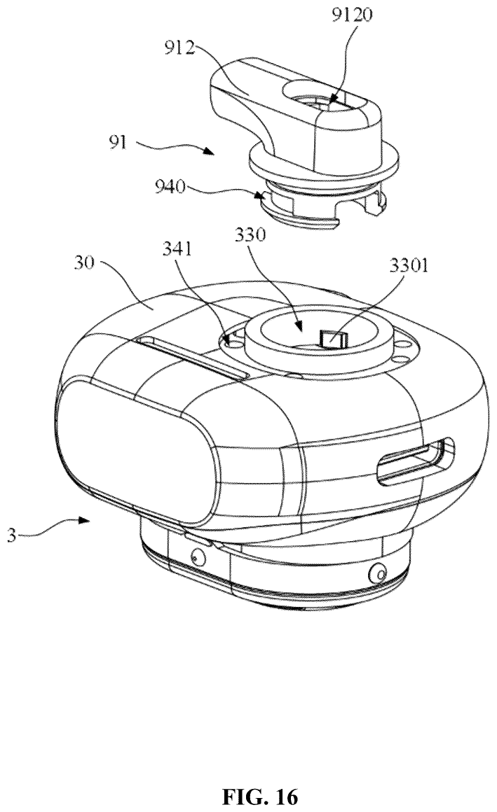

Optionally, as shown in FIG. 13 and FIG. 16, a rotation angle of the stick component 70 around the preset axis Ax3 is in a range from 0 to 135°. For example, the rotation angle of the stick component 70 around the preset axis Ax3 is 30°, 60°, 90°, or 120°.

Such an arrangement facilitates the movement of the microphone component 80 within the effective sound pickup region, improving the voice capture performance, while also making it easier to adjust the position of the microphone component 80 and reducing the probability of adjusting the microphone component 80 to an unreasonable position. If the range of the rotation angle is larger, it may increase the probability of adjusting the microphone component 80 to an unreasonable position, which is unfavorable for the operation of the microphone component 80 and affects the user experience.

Optionally, as shown in FIG. 13 and FIG. 16, the stick component 70 is provided with a limiting groove 940, the limiting groove 940 extends along the rotation direction of the stick component 70, and the loudspeaker component 3 is provided with a limiting protrusion 3301, and the limiting protrusion 3301 is slidably inserted into the limiting groove 940. Two ends of the limiting groove 940 are configured to restrict the limiting protrusion 3301 from sliding, and thus to restrict the relative rotation of the stick component 70 and the loudspeaker component 3.

Optionally, as shown in FIG. 1, FIG. 13, and FIG. 14, one end of the stick component 70 is connected to the loudspeaker component 3, and the other end is connected to the microphone component 80. In a natural state, the elastic sheet 71 is gradually bent toward the user's face along a direction from an end close to the loudspeaker component 3 to an end away from the loudspeaker component 3.

The extension direction of the stick component 70 may be close to or consistent with the extension direction of the elastic sheet 71. By setting the elastic sheet 71 to be gradually bent toward the user's face along the direction from the end close to the loudspeaker component 3 to the end away from the loudspeaker component 3, the microphone component 80 can be located closer to the sound pickup region to better collect the user's voice, thereby improving sound pickup performance. At the same time, the probability of interference between the stick component 70 and the user's face can be reduced, thereby enhancing wearing comfort.

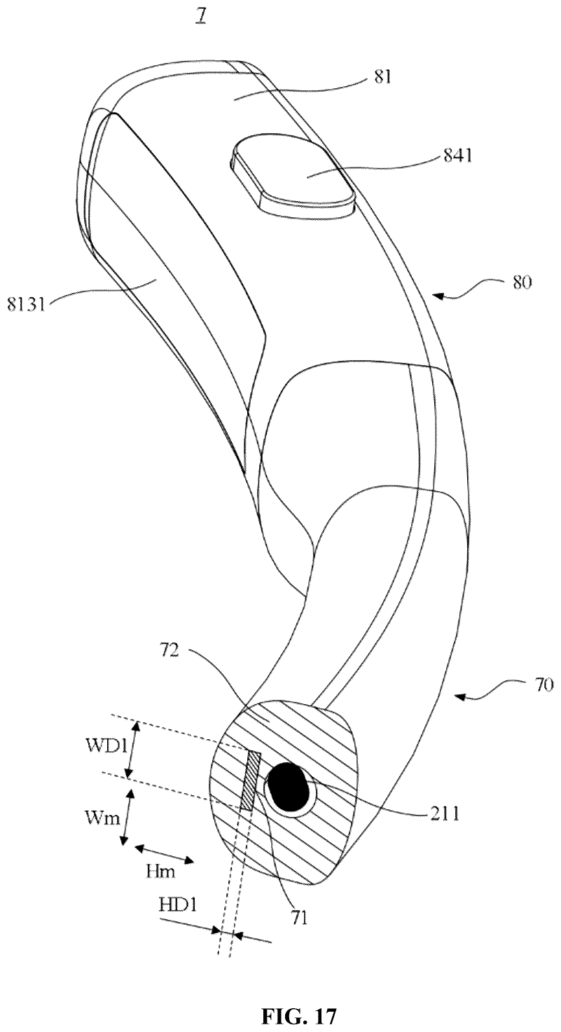

Optionally, as shown in FIG. 14 and FIG. 17, a ratio of the dimension HD1 of the elastic sheet 71 along the thickness direction Hm to the dimension WD1 of the elastic sheet 71 along the width direction Wm is in a range from 0.1 to 0.3. For example, the ratio of the dimension HD1 of the elastic sheet 71 along the thickness direction Hm to the dimension WD1 of the elastic sheet 71 along the width direction Wm is 0.12, 0.15, 0.2, 0.25.

Set up in this way, the elastic sheet 71 can easily deform along the thickness direction Hm while being difficult to deform along the width direction Wm, thereby facilitating adjustment of the position of the microphone component 80. If the ratio is too large, the elastic sheet 71 is not easy to deform along the thickness direction Hm, which increases the degree of difficulty of the user in adjusting the position of the microphone component 80; if the ratio is too small, the elastic sheet 71 has a poor mechanical strength and provides insufficient supporting and shaping effect, which will adversely affect the structural stability of the stick component 70.

Optionally, the elastic sheet 71 is a titanium sheet. This can make the elastic sheet 71 have good mechanical strength and deformation capacity, which is conducive to improving the service life of the elastic sheet 71.

Optionally, the dimension HD1 of the elastic sheet 71 along the thickness direction Hm is in a range from 0.3 mm to 0.5 mm. Further, the dimension HD1 of the elastic sheet 71 along the thickness direction Hm is in a range from 0.36 mm to 0.44 mm.

Set up in this way, the elastic sheet 71 can easily deform along the thickness direction Hm, so that it is easy to adjust the position of the microphone component 80, and the elastic sheet 71 can have sufficient mechanical strength, thereby having a good supporting and shaping function. If the dimension is too large, the elastic sheet 71 is not easy to deform along the thickness direction Hm, which increases the degree of difficulty of the user in adjusting the position of the microphone component 80; if the dimension is too small, the elastic sheet 71 has a poor mechanical strength and insufficient supporting and shaping effect.

Optionally, the dimension WD1 of the elastic sheet 71 along the width direction Wm is in a range from 1.8 mm to 2.2 mm. Further, the dimension WD1 of the elastic sheet 71 along the width direction Wm is in a range from 1.96 mm to 2.04 mm.

Set up in this way, the elastic sheet 71 may be difficult to deform along the width direction Wm, which facilitates the adjustment of the position of the microphone component 80, and the elastic sheet 71 can also have sufficient mechanical strength, thereby having a good supporting and shaping function. If the dimension is too large, the elastic sheet 71 will occupy a great space, which is unfavorable for miniaturizing the stick component 70; if the dimension is too small, the elastic sheet 71 will have poor mechanical strength, resulting in insufficient support and shaping, and it will also affect the directional deformation of the elastic sheet 71.

Optionally, the microphone component 80 is fixedly connected to an end of the stick component 70 away from the preset axis Ax3, as shown in FIG. 1 and FIG. 13. When the microphone component 80 is in operation, an end of the stick component 70 close to the preset axis Ax3 is close to the user's ear, and the end of the stick component 70 away from the preset axis Ax3 is close to the user's mouth, allowing the earphone 1 to extend from the user's ear to the user's mouth.

The microphone component 80 includes an accommodation shell 81, a microphone 82, a microphone circuit board 83, and a key module 84. The accommodation shell 81 is provided with an accommodation cavity 810 and a microphone hole 811 in communication with the accommodation cavity 810, the microphone 82 and the microphone circuit board 83 are disposed in the accommodation cavity 810, and the microphone 82 is fixed to the microphone circuit board 83 and is opposite to the microphone hole 811. The accommodation shell 81 includes two opposite first shell walls 8101 along the width direction Wm and two opposite second shell walls 8102 disposed along the thickness direction Hm, and an end wall 8103 away from the preset axis Ax3. The microphone hole 811 is disposed on the second shell wall 8102 or the end wall 8103, the key module 84 is disposed on the first shell wall 8101, and the key module 84 is configured to turn on or turn off the microphone 82.

External sound may be transmitted to the microphone 82 through the microphone hole 811, the microphone 82 may convert the captured sound into an electrical signal, and the microphone circuit board 83 may be provided with a circuit that cooperates with the microphone 82.

By disposing the microphone hole 811 on the second shell wall 8102 or the end wall 8103, and the key module 84 on the first shell wall 8101, the key module 84 and the microphone hole 811 may be placed on different surfaces of the accommodation shell 81, respectively. There may be a large distance between the key module 84 and the microphone hole 811, which can reduce the situation where the microphone hole 811 is blocked when the user presses the key module 84 and minimize the adverse impact of mechanical noise from key presses on the sound pickup of the microphone component 80, thereby enhancing the sound pickup performance of the microphone component 80 and making it easier for the user to press the key module 84.

Optionally, the microphone circuit board 83 may be a flexible printed circuit (FPC) board.

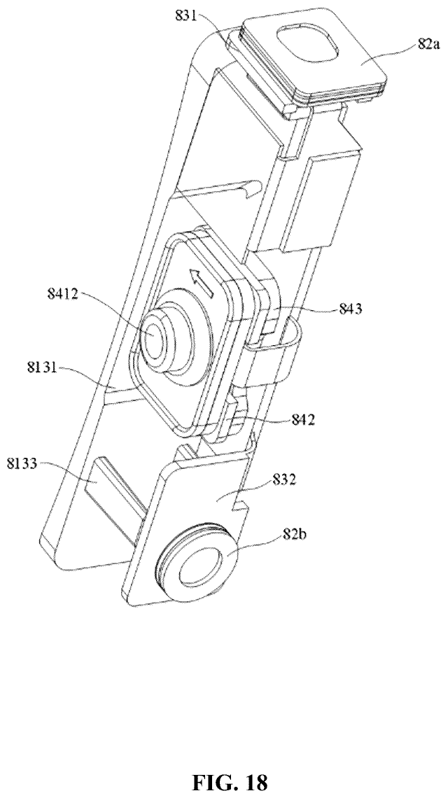

Optionally, as shown in FIG. 14, FIG. 15, and FIG. 18, the first shell wall 8101 is provided with a key hole 8104, the key module 84 includes a key 841 and an adapter circuit board 842, and the adapter circuit board 842 is electrically connected to the microphone circuit board 83. The adapter circuit board 842 is disposed in the accommodation cavity 810, the key 841 passes through the key hole 8104 and seals the key hole 8104, the adapter circuit board 842 is provided with a switch 8421, and the key 841 abuts against the switch 8421 to control the microphone 82 to be turned on or off by pressing to trigger the switch 8421.

The adapter circuit board 842 and the key 841 can effectively control the microphone 82 to be turned on or off, eliminating the need to dispose the switch 8421 on the microphone circuit board 83, which better accommodates the structural design of the earphone 1. Moreover, compared to integrating circuits of the microphone circuit board 83 and the adapter circuit board 842 into a single board, the separate arrangement of the microphone circuit board 83 and the adapter circuit board 842 is conducive to reducing crosstalk between the circuits on the microphone circuit board 83 and the adapter circuit board 842. Sealing the key hole 8104 through the key 841 is conducive to reducing the ingress of external moisture and dust into the accommodation cavity 810, thereby enhancing the sealing performance.

Optionally, the adapter circuit board 842 is a flexible printed circuit (FPC) board.

Optionally, as shown in FIG. 14, FIG. 15, and FIG. 18, the key 841 includes an elastic body 8412 and a key body 8411 abutting against the elastic body 8412, with the elastic body 8412 located within the accommodation cavity 810 and sealing the key hole 8104 from the accommodation cavity 810. The key body 8411 is disposed on a side of the elastic body 8412 that is away from the accommodation cavity 810 and exposed through the key hole 8104. The key module 84 includes a fixing plate 843, the fixing plate 843 being supported on a side of the adapter circuit board 842 away from the elastic body 8412 to clamp the adapter circuit board 842 between the fixing plate 843 and the elastic body 8412, and the fixing plate 843 is fixedly disposed within the accommodation cavity 810.

The elastic body 8412 can be elastically deformed, and when the key body 8411 is pressed, a force can be exerted on the adapter circuit board 842 through the elastic body 8412 to trigger the switch 8421. The installation of the adapter circuit board 842 is facilitated by the fixing plate 843, which makes the structure of the key module 84 more solid and stable after the adapter circuit board 842 is installed.

In some embodiments, the elastic body 8412 is pressurized and tightly pressed against the accommodation shell 81 to seal the key hole 8104. In other embodiments, the elastic body 8412 is seamlessly connected to the accommodation shell 81 by injection molding or compression molding.

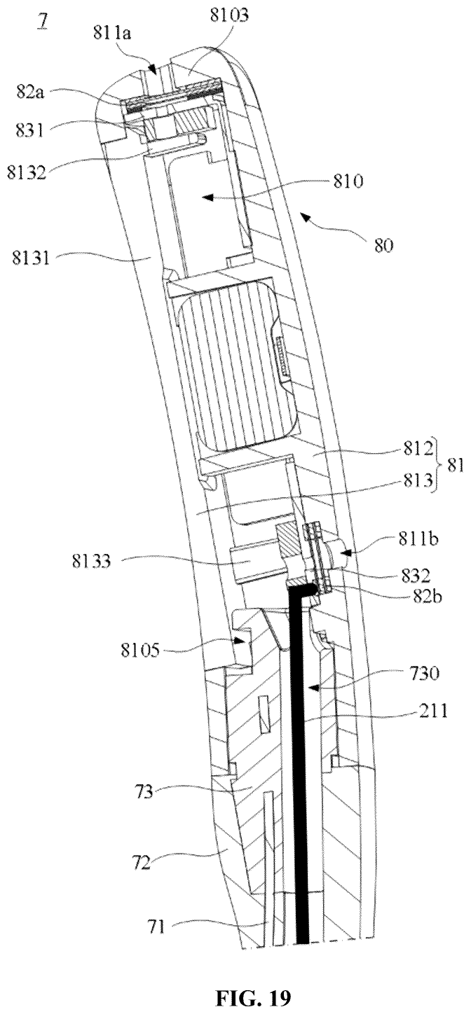

Optionally, as shown in FIG. 14, FIG. 15, and FIG. 19, there are at least two microphones 82 including a first microphone 82a and a second microphone 82b, and there are at least two microphone holes 811 including a first microphone hole 811a and a second microphone hole 811b, the first microphone hole 811a being disposed at the end wall 8103, and the second microphone hole 811b being disposed at the second shell wall 8102. The first microphone 82a and the second microphone 82b are fixedly disposed on the microphone circuit board 83 and correspond to the first microphone hole 811a and the second microphone hole 811b, respectively. The second microphone hole 811b is located closer to an end of the accommodation shell 81 close to the preset axis Ax3, among the two ends of the accommodation shell 81.

Specifically, the first microphone hole 811a and the second microphone hole 811b have different outward orientations, with the second microphone hole 811b being farther from the mouth and thus collecting more environmental noise, while the first microphone hole 811a is closer to the mouth and collects more user speech. Therefore, by utilizing both the first microphone hole 811a and the second microphone hole 811b, environmental noise can be effectively filtered out. Further, the second microphone hole 811b is disposed on the second shell wall 8102 that is away from the user's face to enhance the collection of the environmental noise.

In addition, disposing at least two microphones 82 can enhance the sound pickup effect, and the at least two microphones 82 are far away from each other, which can facilitate sound pickup in a wider range and reduce mutual interference. Additionally, the two microphones 82 are far away from each other, and the two microphones 82 are not easy to be blocked by the user at the same time when the key module 84 is pressed.

Optionally, as shown in FIG. 14, FIG. 15, and FIG. 19, the accommodation shell 81 includes a shell body 812 and a cap body 813. The shell 812 has a portion of the second shell wall 8102, forming an opening that communicates with the accommodation cavity 810. The cap body 813 covers the opening to form another portion of the second shell wall 8102. Such a configuration facilitates the assembly of the various parts inside the accommodation shell 81.

The microphone circuit board 83 includes a first fixing plate portion 831 and a second fixing plate portion 832. The first fixing plate portion 831 is opposite to the end wall 8103 and is used to fix the first microphone 82a. The second fixing plate portion 832 is opposite to the corresponding second shell wall 8102 and is used to fix the second microphone 82b. Such a configuration facilitates the installation of the microphone 82, ensuring a more secure and stable electrical connection with the microphone circuit board 83 after installation, helps maintain the microphone 82 in a stable position and allows for a more flexible design of the microphone circuit board 83, which is conducive to the miniaturization of the stick component 70.

The cap body 813 includes a cap plate 8131, a first support protrusion 8132, and a second support protrusion 8133, the first support protrusion 8132 and the second support protrusion 8133 are protrudingly arranged on a side of the cap plate 8131 facing the accommodation cavity 810. The first support protrusion 8132 is disposed opposite to the end wall 8103 to support the first fixing plate portion 831 and/or the first microphone 82a toward the end wall 8103. The second support protrusion 8133 extends toward the corresponding second shell wall 8102 to support the second fixing plate portion 832 and/or the second microphone 82b.

Specifically, the first support protrusion 8132 and the second support protrusion 8133 extend along the same direction, a side surface of the first support protrusion 8132 supports the first fixing plate portion 831, and an end surface of the second support protrusion 8133 along the extension direction supports the second fixing plate portion 832. Such a configuration facilitates the installation of the microphone 82 and the microphone circuit board 83, and makes the internal structure of the accommodation shell 81 more stable and solid after the microphone 82 and the microphone circuit board 83 are installed. Furthermore, there are two or more second support protrusions 8133 to improve the limiting effect on the second fixing plate portion 832.

Optionally, as shown in FIG. 13 to FIG. 15, and FIG. 19, the stick component 70 includes a first plug-in block 73 fixedly disposed at an end of the elastic sheet 71 away from the preset axis Ax3, and the elastic wrapping body 72 further extends to wrap a portion of the outer periphery of the first plug-in block 73. The first plug-in block 73 is provided with a first lead hole 730. An end of the accommodation shell 81 close to the preset axis Ax3 is provided with the first plug-in hole 8105, the first plug-in block 73 is inserted into the first plug-in hole 8105, and the microphone circuit board 83 is connected to the wire 211, and the wire 211 is threaded from the accommodation cavity 810 through the first lead hole 730 into the elastic wrapping body 72 to be led to the loudspeaker component 3.

Such a configuration facilitates the assembly and connection between the stick component 70 and the microphone component 80.

The first plug-in hole 8105 may be in communication with the accommodation cavity 810. By providing the first lead hole 730 on the first plug-in block 73, the wire 211 can be fixed and protected, and it is easy to thread the wire 211 from the accommodation cavity 810 into the elastic wrapping body 72. By threading the wire 211 into the elastic wrapping body 72, the elastic wrapping body 72 protects the wire 211, and the wire 211 can move relative to the elastic wrapping body 72 and the first plug-in block 73, thereby reducing the impact on the wire 211 during deformation of the elastic sheet 71 and improving the service life of the wire 211.

A portion of the outer periphery of the first plug-in block 73 that is not wrapped by the elastic wrapping body 72 may be inserted into the first plug-in hole 8105. Furthermore, the outer periphery of the elastic wrapping body 72 is flush with the outer periphery of the accommodation shell 81 at the connection to improve aesthetic appearance.

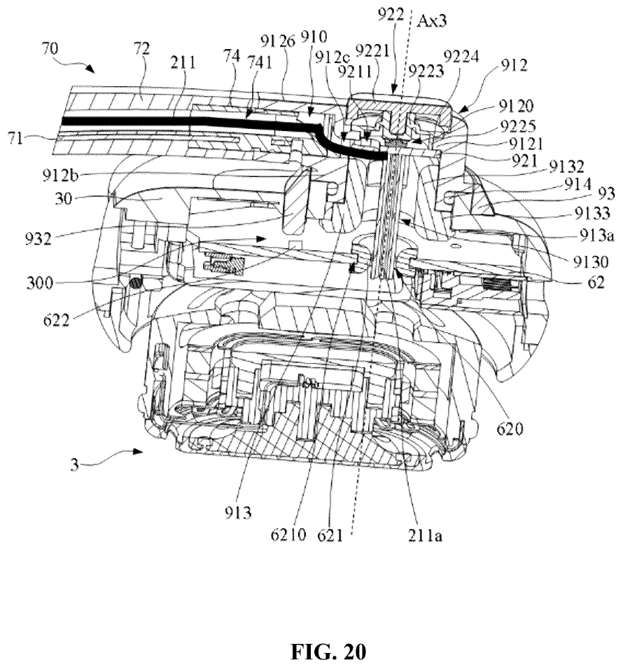

Optionally, the stick microphone component 7 includes the rotating shaft mechanism 91 as shown in FIG. 13 to FIG. 15, and FIG. 20. The stick component 70 includes a second plug-in block 74 fixedly disposed at the end of the elastic sheet 71 close to the preset axis Ax3, and the elastic wrapping body 72 further extends to wrap a portion of the outer periphery of the second plug-in block 74. The rotating shaft mechanism 91 is rotatably disposed on the loudspeaker component 3 around the preset axis Ax3. The rotating shaft mechanism 91 is provided with a second plug-in hole 910, and the second plug-in block 74 is inserted into the second plug-in hole 910. The second plug-in block 74 is provided with a second lead hole 741, and the wire 211 of the stick microphone component 7 is threaded from the elastic wrapping body 72 into the rotating shaft mechanism 91 through the second lead hole 741, and enters the loudspeaker component 3 through the rotating shaft mechanism 91.

Such a configuration facilitates the assembly and connection between the stick component 70 and the rotating shaft mechanism 91.

By rotatably disposing the rotating shaft mechanism 91 on the loudspeaker component 3 around the preset axis Ax3, the stick component 70 and the microphone component 80 can rotate around the preset axis Ax3.

The second plug-in hole 910 may be in communication with the rotating shaft mechanism 91. By providing the second lead hole 741 on the second plug-in block 74, the wire 211 can be fixed and protected, thereby facilitating the threading of the wire 211 from the elastic wrapping body 72 into the rotating shaft mechanism 91. The wire 211 can move relative to the elastic wrapping body 72 and the second plug-in block 74, so that the pulling of the wire 211 can be reduced when the elastic sheet 71 is deformed, which is conducive to improving the service life of the wire 211.

A portion of the outer periphery of the second plug-in block 74 that is not wrapped by the elastic wrapping body 72 may be inserted into the second plug-in hole 910. Further, the outer periphery of the elastic wrapping body 72 is flush with the outer periphery of the rotating shaft mechanism 91 at the connection to improve aesthetic appearance.

The following is an exemplary structure of the stick microphone component 7, or the like of an earphone according to embodiments of the present disclosure.

As shown in FIG. 1, FIG. 13, and FIG. 15, in some embodiments, the earphone 1 may include the wearing component 2, the loudspeaker component 3, and the stick microphone component 7. The wearing component 2 is connected to the loudspeaker component 3, and the stick microphone component 7 is rotatably disposed on the loudspeaker component 3 around the preset axis Ax3. The loudspeaker component 3 includes a shell component 30 and a loudspeaker, the shell component 30 being provided with an accommodation space 300 and a pivot hole 330 in communication with the accommodation space 300, and the loudspeaker being provided in the accommodation space 300. The stick microphone component 7 includes a key module 92, the stick component 70, and the rotating shaft mechanism 91. The rotating shaft mechanism 91 is threaded through the pivot hole 330 and is rotatable around the preset axis Ax3 relative to the accommodation component 30. The rotating shaft mechanism 91 includes a pivot base 912 and a pivot bracket 913, the pivot base 912 and the pivot bracket 913 being assembled along the preset axis Ax3. A portion of the pivot base 912 is disposed outside the shell component 30 and is connected to the stick component 70. The key module 92 includes a key circuit board 921 and a key 922. The key circuit board 921 is sandwiched between the pivot base 912 and the pivot bracket 913. The key circuit board 921 is provided with a switch 9210, and the key 922 is disposed on the pivot base 912 and used to press the switch 9210.

The loudspeaker may include at least one of the bone-conduction loudspeaker 40 and the air-conduction loudspeaker 50.

The loudspeaker component 3 may transmit sound to the human ear. The wearing component 2 may hang the loudspeaker component 3 near the user's ear, and the wearing component 2 may also apply a force to the loudspeaker component 3 to cause the loudspeaker component 3 to fit a facial region near the user's ear. The stick microphone component 7 may capture a sound emitted from the mouth to collect the user's voice.

The assembly connection between the stick component 70 and the loudspeaker component 3 is facilitated by setting the rotating shaft mechanism 91, and by setting the rotating shaft mechanism 91 to rotate around the preset axis Ax3 relative to the accommodation component 30, the stick microphone component 7 can rotate around the preset axis Ax3, so that the stick microphone component 7 has a greater movement range to meet different needs for capturing sound. Additionally, the stick microphone component 7 can be switched between a stowed position and a working position by rotating around the preset axis Ax3.

The key module 92 may be configured to trigger the stick microphone component 7 to operate. For example, the user may answer a phone call by pressing the key module 92, and the stick microphone component 7 picks up the user's voice when the user speaks.

Specifically, the key 922 may be provided on a portion of the pivot base 912 outside the shell component 30 and exposed to the outside world for easy pressing. A portion of the pivot bracket 913 may be disposed within the shell component 30 to restrict the pivot bracket 913 from detaching from the accommodation component 30.

By setting the key circuit board 921 to be sandwiched between the pivot base 912 and the pivot bracket 913, the key circuit board 921 can be fixed to the rotating shaft mechanism 91, and when the rotating shaft mechanism 91 rotates, the key circuit board 921 rotates in synchronization with the rotating shaft mechanism 91, and the key circuit board 921 can be assembled and fixed during the assembly process of the pivot base 912 and the pivot bracket 913, which facilitates the installation of the key circuit board 921 and improves the assembly efficiency.

Optionally, the pivot base 912 is set to be assembled to the shell component 30 from the exterior of the shell component 30 and partially disposed within a pivot hole 330. Such a configuration can facilitate the assembly of the pivot base 912 on the accommodation component 30, and at the same time facilitate the assembly and connection of the pivot base 912 and the stick component 70.

The pivot bracket 913 is provided to be assembled with the pivot base 912 from the accommodation space 300 such that the pivot base 912 is retained in the pivot hole 330. Such a configuration can facilitate restricting at least a portion of the pivot bracket 913 in the accommodation component 30, which facilitates the assembly of the pivot base 912 on the shell component 30 through the pivot bracket 913, thereby limiting the pivot base 912 from detaching from the accommodation component 30. During the assembly of the pivot base 912 and the pivot bracket 913, the assembly of the key circuit board 921 may be carried out at the same time to improve the assembly efficiency.

Optionally, as shown in FIG. 13 and FIG. 16, the pivot base 912 is provided with a limiting groove 940, the limiting groove 940 extends along the rotation direction of the pivot base 912, the pivot hole 330 is provided with a limiting protrusion 3301, and the limiting protrusion 3301 is slidably inserted into the limiting groove 940. The limiting protrusion 3301 can slide along the extension direction of the limiting groove 940 to allow relative rotation of the pivot base 912 and the loudspeaker component 3. Two ends of the limiting groove 940 are configured to limit the limiting protrusion 3301 from sliding and thus limiting the relative rotation of the pivot base 912 and the loudspeaker component 3.

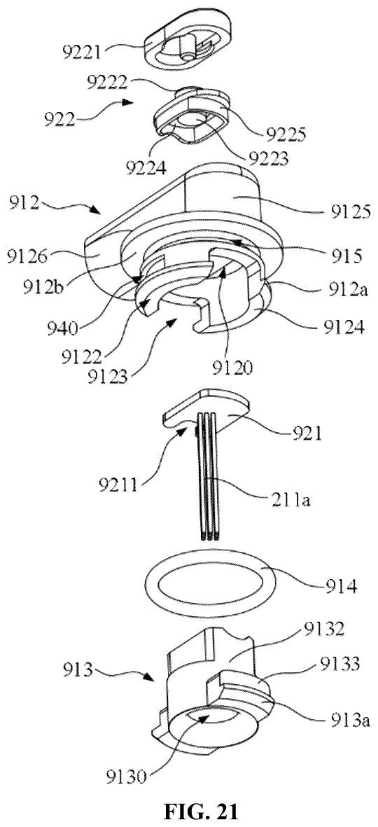

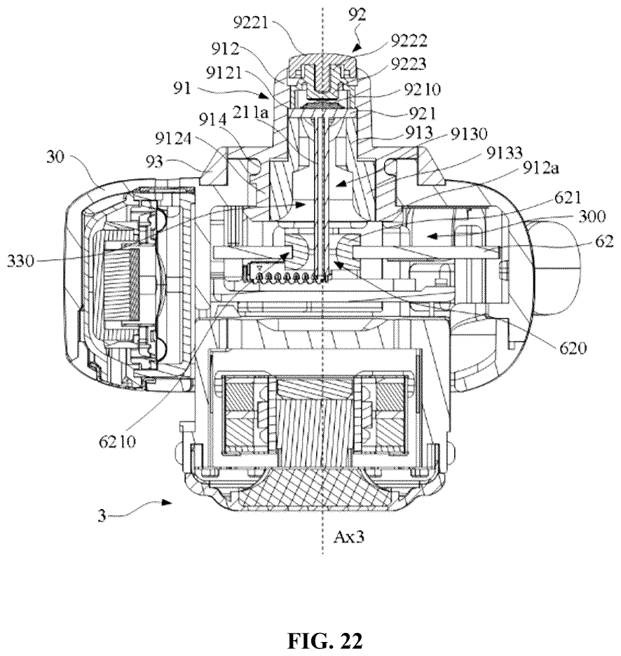

Optionally, as shown in FIG. 15, FIG. 20 to FIG. 22, the pivot base 912 is provided with an assembly hole 9120 extending through along the preset axis Ax3, and a support flange 9121 extending from an inner wall of the assembly hole 9120. One end of the pivot bracket 913 extends into the assembly hole 9120. The key circuit board 921 is supported between the support flange 9121 and one end of the pivot bracket 913. The switch 9210 is disposed on a side of the key circuit board 921 away from the accommodation space 300, and the key 922 is accommodated in the assembly hole 9120 and abuts against the switch 9210.

The assembly hole 9120 is provided to facilitate the contact between the key circuit board 921 and the key 922. By accommodating the key 922 in the assembly hole 9120, the structure of the stick microphone component 7 can be made compact, and the assembly hole 9120 can limit the key 922, thus facilitating the assembly of the key 922. Providing the support flange 9121 increases the contact region between the pivot base 912 and the key circuit board 921, improving the supporting and fixing effect of the pivot base 912 on the key circuit board 921, thereby improving the structural stability.

Optionally, as shown in FIG. 15, FIG. 20 to FIG. 22, the key 922 includes a key cap 9221 and an elastic abutting member 9222, the elastic abutting member 9222 is disposed in the assembly hole 9120 and is fixedly supported on a side of the support flange 9121 away from the key circuit board 921, and the elastic abutting member 9222 abuts against the switch 9210. The key cap 9221 is disposed on a side of the elastic abutting member 9222 away from the switch 9210, and is exposed through the assembly hole 9120. The support flange 9121 is disposed as a ring around the preset axis Ax3. The elastic abutting member 9222 is integrally molded on the support flange 9121 along an annular direction of the support flange 9121 to seal the assembly hole 9120 at the support flange 9121.

The key cap 9221 is exposed for easy pressing. The elastic abutting member 9222 is elastic, and the key cap 9221 can transfer the pressing action to the key circuit board 921 through the elastic abutting member 9222 to trigger the switch 9210. By disposing the support flange 9121 to support the elastic abutting member 9222, the contact area between the pivot base 912 and the elastic abutting member 9222 can be increased, which facilitates the installation of the key cap 9221 and the elastic abutting member 9222, and also facilitates the elastic abutting member 9222 to seal the assembly hole 9120.

By disposing the elastic abutting member 9222 to be integrally molded on the support flange 9121 along the annular direction of the support flange 9121, the elastic abutting member 9222 can seal the assembly hole 9120 well, which can prevent the intrusion of water and dust into the inside the shell component 30 and simplify the structure. Further, the elastic abutting member 9222 is integrally molded on the support flange 9121 along the annular direction of the support flange 9121 through secondary injection molding or compression molding.

Optionally, as shown in FIG. 15, FIG. 20 to FIG. 22, the elastic abutting member 9222 includes an abutting post 9223, an annular sealing portion 9224 that surrounds the abutting post 9223, and a cartridge sealing portion 9225 that is connected to a side of the annular sealing portion 9224 facing the key circuit board 921 and surrounds the abutting post 9223. The annular sealing portion 9224 is supported on the support flange 9121 and seamlessly connected to the support flange 9121, and the cartridge sealing portion 9925 extends to an inner annular surface of the support flange 9121 and is seamlessly connected to the inner annular surface of the support flange 9121. Two ends of the abutting post 9223 abut against the key cap 9221 and the switch 9210, respectively.

The installation of the elastic abutting member 9222 is facilitated by disposing the annular sealing portion 9224 to be supported on the support flange 9121. By disposing the cartridge sealing portion 9225 to extend to the inner annular surface of the support flange 9121, the contact area between the pivot base 912 and the elastic abutting member 9222 can be increased, and the pivot base 912 and the elastic abutting member 9222 are sealed and abutted along different directions, which can improve the sealing effect of the elastic abutting member 9222 on the assembly hole 9120. The abutting post 9223 allows the pressing action from the key cap 9221 to be focused on the abutting post 9223, so that the pressing action can be more centrally transmitted to the switch 9210, which is favorable for the switch 9210 to respond sensitively to the pressing action of the user.

Optionally, as shown in FIG. 15, FIG. 20 to FIG. 22, the pivot bracket 913 is provided with a wiring hole 9130 extending through along the preset axis Ax3, and one side of the key circuit board 921 faces the wiring hole 9130. The wiring hole 9130 and the assembly hole 9120 are in communication. The loudspeaker component 3 includes the control circuit board 62 connected to the wire bundle 211a, the control circuit board 62 being disposed in the accommodation space 300 and opposite to the pivot hole 330. The wire bundle 211a is connected to the key circuit board 921 along the preset axis Ax3 through the wiring hole 9130.

By providing the wiring hole 9130, it can facilitate the arrangement of the wire bundle 211a and realize the electrical connection between the stick microphone component 7 and the control circuit board 62. The wiring hole 9130 and the assembly hole 9120 may be in communication with each other along the preset axis Ax3 so that the wire bundle 211a may extend along the preset axis Ax3, and the preset axis Ax3 is close to or passes through the wire bundle 211a. When the stick microphone component 7 rotates, the wire bundle 211a rotates approximately on the preset axis Ax3 or rotates at a small radius, thereby reducing the pulling and twisting forces exerted by the stick microphone component 7 on the wire bundle 211a, and extending the service life of the wire bundle 211a.

Optionally, as shown in FIG. 15, FIG. 20 to FIG. 22, the control circuit board 62 is provided with a wire hole 620 extending through along the preset axis Ax3, the wire hole 620 is provided opposite to the wiring hole 9130, and the wire bundle 211a extends from a side of the control circuit board 62 away from the pivot hole 330 through the wire hole 620 into the wiring hole 9130 along the preset axis Ax3. The loudspeaker component 3 includes an elastic ring 621, the elastic ring 621 is fixed within the wire hole 620, and the wire bundle 211a is threaded through the elastic ring 621. For example, the elastic ring 621 may be a rubber ring.

The wire hole 620 is available for the wire bundle 211a to pass through so that the wire hole 620 can limit the wire bundle 211a, and by setting the wire hole 620 opposite to the wiring hole 9130, it is favorable for the wire bundle 211a to be extended along the preset axis Ax3, thereby improving the stability of the connection between the wire bundle 211a with the control circuit board 62.

The elastic ring 621 has elasticity, and the elastic ring 621 can be elastically deformed when the wire bundle 211a moves relative to the elastic ring 621, which can reduce the resistance to movement of the wire bundle 211a while limiting the wire bundle 211a, and also prevent the edge of the wire hole 620 from scratching the wire bundle 211a.

Optionally, as shown in FIG. 15, FIG. 20 to FIG. 22, an annular embedding groove 6210 is disposed along a circumferential direction of the elastic ring 621, and a portion of the control circuit board 62 located outside the outer periphery of the wire hole 620 is embedded in the annular embedding groove 6210, such that the elastic ring 621 is snap-fitted to the control circuit board 62.

By disposing the portion of the control circuit board 62 located outside the outer periphery of the wire hole 620 to be embedded in the annular embedding groove 6210, the connection between the elastic ring 621 and the control circuit board 62 can be simplified, which facilitates the assembly and connection between the elastic ring 621 and the control circuit board 62 and improves the connection stability between the elastic ring 621 and the control circuit board 62.

Optionally, as shown in FIG. 15, FIG. 20 to FIG. 22, the pivot base 912 includes an end portion 9122 extending into the pivot hole 330 and/or the accommodation space 300, the end portion 9122 being provided with at least two locking grooves 9123 spaced apart along a circumferential direction. The at least two locking grooves 9123 divide the end portion 9122 into at least two elastic arms 9124 spaced apart from each other along the circumferential direction. The pivot bracket 913 includes a shaft body 9132 and at least two locking blocks 9133 protruding from the outer periphery of the shaft body 9132, the shaft body 9132 being inserted into the assembly hole 9120 and located between the at least two elastic arms 9124. The at least two locking blocks 9133 are respectively embedded in the corresponding locking grooves 9123, so as to be supported between two adjacent elastic arms 9124 within the corresponding locking groove 9123.

The elastic arm 9124 is elastic and can be elastically deformed. By providing the locking groove 9123, the elastic arm 9124 can be easily deformed during the assembly process, making the pivot base 912 easier to assemble. The shaft body 9132 and the at least two locking blocks 9133 may support and limit the at least two elastic arms 9124, limiting the deformation of the elastic arms 9124 after assembly and improving the structural stability. By embedding the at least two locking blocks 9133 respectively into the at least two locking grooves 9123, the pivot base 912 and the pivot bracket 913 can be kept relatively fixed to each other, enabling them to rotate synchronously around the preset axis Ax3.

Optionally, as shown in FIG. 15, FIG. 20 to FIG. 22, first stop edges 913a are respectively protruded on the outer surfaces of the at least two locking blocks 9133. Second stop edges 912a are respectively protruded on the outer surfaces of ends of the at least two elastic arms 9124 that are away from the key module 92. The first stop edge 913a and the second stop edge 912a are complementarily disposed along the circumferential direction of the shaft body 9132, and abut against a side wall surface of the shell component 30 facing the accommodation space 300 at the periphery of the pivot hole 330.

Through the elastic deformation of the elastic arm 9124, the second stop edge 912a may reach the periphery of the pivot hole 330 through the pivot hole 330 and abut against the side wall surface of the shell component 30 facing the accommodation space 300 during assembly to enable the pivot base 912 to snap-fit with the shell component 30 to facilitate assembly of the pivot base 912. The shaft body 9132 and the at least two locking blocks 9133 can support and limit the at least two elastic arms 9124, limiting the detachment of the elastic arms 9124 from the shell component 30 due to deformation after assembly, thereby improving structural stability.

By providing the first stop edge 913a, the shell component 30 can support the pivot bracket 913, thereby facilitating the installation of the pivot bracket 913. By disposing the first stop edge 913a and the second stop edge 912a complementarily along the circumferential direction of the shaft body 9132, the rotating shaft mechanism 91 can be made compact to save space.

Optionally, as shown in FIG. 15, FIG. 20 to FIG. 22, an annular third stop edge 912b protrudes on the outer periphery of the pivot base 912, and the first stop edge 913a and the third stop edge 912b are spaced apart along the preset axis Ax3. The third stop edge 912b abuts against a side wall surface of the shell component 30 away from the accommodation space 300.

In this way, the second stop edge 912a and the third stop edge 912b can be spaced apart along the preset axis Ax3. During the assembly process, the third stop edge 912b plays a role in positioning. After the pivot base 912 is inserted into the pivot hole 330 in place, the third stop edge 912b restricts further movement of the pivot base 912 toward the accommodation space 300, facilitating the assembly of the pivot base 912 and enhancing the structural stability after assembly.

Optionally, as shown in FIG. 15, FIG. 20 to FIG. 22, the rotating shaft mechanism 91 includes a sealing ring 914, and an annular ring-accommodating groove 915 is circumferentially disposed along the outer periphery of the pivot base 912, and the annular ring-accommodating groove 915 is spaced from the at least two locking grooves 9123 along the preset axis Ax3. The sealing ring 914 is sleeved on the pivot base 912 and abuts between the pivot base 912 and a hole wall of the pivot hole 330.

The annular ring-accommodating groove 915 may be configured to restrict the sealing ring 914 from sliding after installation. By sleeving the sealing ring 914 on the pivot base 912 and having it abut between the pivot base 912 and the hole wall of the pivot hole 330, a seal is formed between the pivot base 912 and the hole wall of the pivot hole 330, thereby preventing water and dust from entering the interior of the shell component 30. By spacing the annular ring-accommodating groove 915 apart from the at least two locking grooves 9123 along the preset axis Ax3, interference with the sealing effect of the annular ring-accommodating groove 915 caused by the locking grooves 9123 can be reduced.

Optionally, as shown in FIG. 15, FIG. 19 to FIG. 21, the pivot base 912 is provided with a plug-in hole, and the stick component 70 is provided with a plug-in portion, the plug-in portion being inserted into the plug-in hole. A bottom wall of the plug-in hole is provided with a wire-through hole 912c in communication with the assembly hole 9120. The pivot bracket 913 is provided with a first notch 9134 at one end for supporting the key circuit board 921, and the key circuit board 921 is provided with a second notch 9211 in communication with the first notch 9134. The wire bundle 211a includes the wire 211 for leading to the stick component 70, the wire 211 being led from a side of the key circuit board 921 away from the switch 9210 through the first notch 9134 and the second notch 9211 into the plug-in hole, and then led to the stick component 70.

The plug-in portion may be the second plug-in block 74, and the plug-in hole may be the second plug-in hole 910. The assembly and connection between the pivot base 912 and the stick component 70 can be facilitated by inserting the plug-in portion into the plug-in hole. Through the wire 211, the control circuit board 62 or the key circuit board 921 can control the operating state of the stick component 70. By providing the wire-through hole 912c on the bottom wall of the plug-in hole, the wire 211 may extend from the assembly hole 9120 to the wire-through hole 912c and then extend to the plug-in hole through the wire-through hole 912c, which may reduce the lead path length of the wire 211. By disposing the first notch 9134 and the second notch 9211 to avoid the wire 211, the structure of the rotating shaft mechanism 91 can be simplified, the routing of the wire 211 can be facilitated, and pulling on the wire 211 can be reduced.

Optionally, as shown in FIG. 15, FIG. 20 to FIG. 22, the loudspeaker component 3 includes an annular light guide 93, the annular light guide 93 is disposed around the pivot hole 330, and a portion of the annular light guide 93 extends into the accommodation space 300. The loudspeaker component 3 includes the control circuit board 62 disposed within the accommodation space 300, the control circuit board 62 is provided with a light-emitting element 622, the light-emitting element 622 being configured to emit light and the light guide being configured to transfer the light emitted by the light-emitting element 622 to the exterior of the shell component 30.

The light serves to prompt the user. By disposing the annular light guide 93 around the pivot hole 330, the light-emitting range can be made larger, making the light indication more noticeable and easier for the user or others to observe. Additionally, this arrangement allows the annular light guide 93 to be positioned close to the key module 92, thereby reducing the space occupied by the key module 92 and the annular light guide 93, resulting in a more compact structure, facilitating a compact connection between the key circuit board 921 and the light-emitting element 622 with the control circuit board 62, and reducing the wiring length.

Further, the annular light guide 93 around the pivot hole 330 allows for the light-emitting element 622 and the wire 211 connecting to the stick microphone component 7 to be arranged compactly on the control circuit board 62.

Optionally, as shown in FIG. 15, FIG. 20 to FIG. 22, the annular light guide 93 includes an annular light guide body 931 and a light guide post 932 connected to the annular light guide body 931, an annular groove 340 surrounding the pivot hole 330 and spaced apart from the pivot hole 330 is disposed on a side of the shell component 30 away from the accommodation space 300. At a bottom wall of the annular groove 340, the shell component 30 is provided with a light guide hole 341 that is in communication with the annular groove 340 and the accommodation space 300, the annular light guide body 931 is embedded in the annular groove 340, the light guide post 932 passes through the light guide hole 341, and the light-emitting element 622 is configured to at least emitting light toward the light guide post 932.

The assembly and fixation of the annular light guide 93 on the shell component 30 may be facilitated by setting the annular groove 340. The light guide post 932 may be configured to propagate light, and by threading the light guide post 932 through the light guide hole 341, light can be propagated from the inside of the shell component 30 to the outside of the shell component 30. Through the light guide post 932, the shell component 30 may limit the annular light guide 93, which facilitates a stable connection between the annular light guide 93 and the shell component 30.

Further, the light guide post 932 tightly fits with the light guide hole 341, and the connection between the annular light guide 93 and the shell component 30 can be realized by threading the light guide post 932 through the light guide hole 341.

Optionally, there may be a plurality of light guide posts 932. The cross-section of the light guide post 932 perpendicular to the preset axis Ax3 may be cylindrical, or may be curved along the circumferential direction of the pivot hole 330.

Optionally, as shown in FIG. 15, FIG. 20 to FIG. 22, the pivot base 912 includes a main shaft base 9125 and a connecting portion 9126 protrudingly provided on the outer periphery of the main shaft base 9125, the connecting portion 9126 is provided with a plug-in hole, and the stick component 70 is provided with a plug-in portion, the plug-in portion being inserted into the plug-in hole. A portion of the main shaft base 9125 may be inserted into the pivot hole 330.

The assembly and connection between the pivot base 912 and the stick component 70 are facilitated by inserting the plug-in portion into the plug-in hole.

The plug-in portion may be the second plug-in block 74, and the plug-in hole may be the second plug-in hole 910. The connecting portion 9126 stops the annular light guide body 931 along the preset axis Ax3. In this way, the annular light guide body 931 can be prevented from detaching from the annular groove 340 along the preset axis Ax3, which is conducive to improving the structural stability of the annular light guide 93.

Optionally, the stick microphone component 7 includes the microphone component 80, as shown in FIG. 15, FIG. 20 to FIG. 22. The microphone component 80 is fixedly connected to an end of the stick component 70 away from the loudspeaker component 3. The microphone component 80 includes the accommodation shell 81 and the microphone 82. The microphone 82 is electrically connected to the control circuit board 62 via the wire 211. The control circuit board 62 is configured to control the light-emitting element 622 to emit light when the microphone 82 is in a sound pickup state.

The microphone component 80 may capture sounds from the mouth to collect the user's voice. The stick component 70 may be connected between the microphone component 80 and the loudspeaker component 3, and by controlling the movement of the stick component 70, the microphone component 80 may be controlled to be in different positions and postures. For example, when the microphone component 80 is finished using, the stick component 70 can be controlled to move the microphone component 80 away from the sound pickup region and toward the wearing component 2, thereby positioning the microphone component 80 in a stowed state.

The microphone 82 is in the sound pickup state when it is turned on, at which point the microphone 82 can operate. By using the control circuit board 62 to control the light-emitting element 622 to emit light when the microphone 82 is in the sound pickup state, it allows users to confirm whether the microphone 82 is turned on.

Further, the intensity or color of light emitted by the light-emitting element 622 may change after the microphone 82 captures the user's voice, as compared to a situation where the microphone 82 does not capture the user's voice. In some embodiments, the light-emitting element 622 is configured so that the intensity or color of the light emitted is changeable depending on the magnitude of the user's voice. In some embodiments, the light-emitting element 622 communicates a message to the outside world by adjusting the frequency of the light-emitting flashes.

In some embodiments, the user may make a telephone call to the outside world through the earphone 1, and the light-emitting element 622 may illuminate to indicate that a call is in progress after the call is connected.

In some embodiments, the light-emitting element 622 may be illuminated to indicate that the microphone component 80 is in an open state or a closed state. The light-emitting element 622 may also illuminate to indicate the on/off process of the microphone 82. The light-emitting element 622 may illuminate to indicate that the earphone 1 is playing music or is in a mute state.

The above description only covers part of the embodiments of the present disclosure and should not be construed as limiting the scope of patent protection. Any equivalent devices or process modifications based on the content of the present disclosure and the accompanying drawings, or any direct or indirect applications in other related technical fields, shall be deemed to fall within the scope of protection of the present disclosure.

What is claimed is:

1. A wearing component, comprising a headband component, wherein the headband component includes a clamping component, a wire, and a first elastic wrapping body,
the clamping component has a length direction, a thickness direction, and a width direction, the clamping component has a curved shape along the length direction, so that the headband component is wound around a top of a head of a user and provides a clamping force when the wearing component is in a wearing state,
a dimension of the clamping component along the width direction is greater than a dimension of the clamping component along the thickness direction, and the thickness direction faces or is away from the head of the user when the wearing component is in the wearing state,
the first elastic wrapping body includes a wrapping main body, the wrapping main body is molded to enclose an outer periphery of the clamping component and the wire, and the clamping component and the wire located within the wrapping main body at least partially overlap along the thickness direction,
the wearing component is configured to, when the wearing component is in the wearing state, place a loudspeaker component at an ear of the user or a listening region near the ear, and along a sagittal axis of the user, the loudspeaker component is closer to a face of the user relative to the clamping component, and the wire is closer to a rear side of the head relative to the clamping component.

2. The wearing component of claim 1, wherein a ratio of an overlapping dimension between the clamping component and the wire along the thickness direction to a smaller one of the dimension of the clamping component along the thickness direction and a dimension of the wire along the thickness direction is in a range from 0.6 to 1.

3. The wearing component of claim 2, wherein a ratio of the dimension of the clamping component along the thickness direction to the dimension of the wire along the thickness direction is in a range from 0.5 to 2.

4. The wearing component of claim 1, wherein
the first elastic wrapping body further includes an elastic band integrally molded with the wrapping main body,
two ends of the elastic band are spaced apart from each other along the length direction and are respectively connected to the wrapping main body,
the elastic band and the wrapping main body are separated from each other between connection positions of the two ends of the elastic band and the wrapping main body, and
the elastic band is configured to assist in positioning the clamping component onto the head of the user when the wearing component is in the wearing state.

5. The wearing component of claim 1, wherein the clamping component includes an elastic sheet, and the wire is arranged on a side of the elastic sheet along the width direction and at least partially overlaps with the elastic sheet along the thickness direction.

6. The wearing component of claim 1, wherein
the wearing component includes the headband component and a torsion component,
the torsion component includes an elastic connecting member, the elastic connecting member includes a first connecting segment and a second connecting segment connected to each other, a free end of the first connecting segment is connected to the clamping component and a free end of the second connecting segment is connected to the loudspeaker component to place the loudspeaker component at the ear of the user or the listening region near the ear when the wearing component is in the wearing state,
starting at the free end of the first connecting segment, the first connecting segment has an extension component extending toward a front side of the face of the user along the sagittal axis, the second connecting segment has an extension component extending away from the top of the head along a vertical axis, and the elastic connecting member is configured to undergo torsion as the loudspeaker component contacts the head of the user when the wearing component is in the wearing state.

7. The wearing component of claim 6, wherein
the second connecting segment is connected to the first connecting segment at an obtuse angle, and
when the wearing component is in the wearing state, an angle between the second connecting segment and the vertical axis is smaller than an angle between the first connecting segment and the vertical axis.

8. The wearing component of claim 7, comprising a telescopic component, wherein
the telescopic component includes a fixing portion and a telescopic portion, the fixing portion is connected to an end portion of the clamping component, the telescopic portion is telescopic relative to the fixing portion, and the free end of the first connecting segment is connected to an end of the telescopic portion away from the clamping component.

9. The wearing component of claim 8, wherein
the fixing portion is provided with a sliding groove, the telescopic portion includes a first telescopic segment and a second telescopic segment, the first telescopic segment is slidably disposed in the sliding groove, the second telescopic segment is connected to the first telescopic segment at an obtuse angle, and
when the wearing component is in the wearing state, an angle between the second telescopic segment and the vertical axis is larger than an angle between the first telescopic segment and the vertical axis, and the free end of the first connecting segment is connected to a free end of the second telescopic segment.

10. The wearing component of claim 9, wherein
two ends of the wire extend from the wrapping main body, the wire extends from an outside of the telescopic component to the torsion component and is fixed to the torsion component, and
a length of the wire outside the telescopic component is greater than a maximum extension amount of the telescopic component.

11. The wearing component of claim 10, wherein the torsion component includes a second elastic wrapping body, the second elastic wrapping body is molded to enclose an outer periphery of the elastic connecting member and is provided with a wiring channel, and the wire passes through the wiring channel.

12. The wearing component of claim 11, wherein the torsion component further includes a first plug-in portion and a second plug-in portion disposed at two ends of the elastic connecting member, respectively, the first plug-in portion is plugged into the loudspeaker component, and the second plug-in portion is plugged into the free end of the second telescopic segment.

13. The wearing component of claim 12, wherein the loudspeaker component includes a main shell provided with a plug-in hole, the second elastic wrapping body and the first plug-in portion are inserted into the plug-in hole, and an outlet of the wiring channel is located within the plug-in hole.

14. The wearing component of claim 13, wherein
a flange portion is disposed at an end of the second elastic wrapping body,
the plug-in hole includes a first hole segment and a second hole segment that are in communication with each other, the second hole segment is closer to an interior of the main shell relative to the first hole segment, and an aperture of the first hole segment is greater than an aperture of the second hole segment,
the flange portion is inserted into the first hole segment and a cross-section of the flange portion perpendicular to an insertion direction is adapted to a cross-section of the first hole segment,
the first plug-in portion protrudes from an end surface of the flange portion and is inserted into the second hole segment, and
the outlet of the wiring channel is located at the end surface of the flange portion.

15. The wearing component of claim 10, wherein the telescopic component further includes a retention portion that remains fixed relative to the fixing portion, and the wire outside the telescopic component is retained on the retention portion.

16. The wearing component of claim 15, wherein the wire is configured to move relative to the retention portion as the telescopic portion extends or retracts.

17. The wearing component of claim 8, wherein
the telescopic component includes a locking member, the fixing portion is provided with a first plug-in hole and a first locking hole in communication with the first plug-in hole,
the end portion of the clamping component is inserted into the first plug-in hole, and
the locking member is inserted into the first locking hole and locks the end portion of the clamping component within the first plug-in hole.

18. The wearing component of claim 17, wherein
the telescopic component further includes a decorative portion, the telescopic portion is slidably disposed in the sliding groove,
the first locking hole and the sliding groove are provided on a side of the fixing portion facing the user when the wearing component is in the wearing state, and
the decorative portion is assembled and fixed with the fixing portion to cover the first locking hole, the sliding groove, and a portion of the telescopic portion located within the sliding groove.

19. The wearing component of claim 17, wherein
the end portion of the clamping component has a sheet-like shape and is provided with a second locking hole passing through main surfaces on two sides of the end portion of the clamping component,
the first locking hole and the second locking hole are aligned when the end portion of the clamping component is inserted into the first plug-in hole, and the locking member is a pin inserted into the first locking hole and the second locking hole,
the first elastic wrapping body further includes an embedding portion integrally molded with the wrapping main body, the embedding portion is attached to the main surface on one side of the end portion of the clamping component,
the fixing portion is provided with a second plug-in hole in communication with the first plug-in hole, and the embedding portion is inserted into the second plug-in hole.

20. An earphone, comprising the wearing component of claim 1 and the loudspeaker component connected to the wearing component.
